(19) United States
(12) Patent Application Publication
(10) Pub. No.: US 2025/0187742 A1
(43) Pub. Date: Jun. 12, 2025

(54) MANAGEMENT OF AIRCRAFT PROPULSION IMBALANCE EVENTS

(71) Applicant: Joby Aero, Inc., Santa Cruz, CA (US)

(72) Inventors: William J. Staruk, Worcester, MA (US); Jason Thomas, Melbourne, FL (US)

(21) Appl. No.: 18/977,575

(22) Filed: Dec. 11, 2024

Related U.S. Application Data
(60) Provisional application No. 63/609,091, filed on Dec. 12, 2023.

(51) Int. Cl. B64D 31/16; B64C 29/02; B64D 27/34

(52) U.S. Cl. CPC B64D 31/16; B64C 29/02; B64D 27/34

(57) ABSTRACT

A system and method for detecting and mitigating aircraft propulsor faults uses deliberate speed perturbations of individual propulsors and analysis of resulting vibration spectra to identify problematic units. Distributed sensors monitor vibration across multiple propulsors. A propulsor operates at an adjusted speed different from the ensemble. Resulting vibration characteristics reveal if the adjusted propulsor is an anomaly source. Its unique signature emerges in the vibration frequency data. The system cycles propulsors through adjusted speeds, detects correlated frequency shifts, and isolates faulty units. Targeted mitigation then acts only on identified bad propulsors while others remain operational. This enables automated in-flight troubleshooting of vibration issues and pinpointed mitigation.

### CROSS-REFERENCE TO RELATED APPLICATION

This patent application claims the benefit of U.S. Provisional Patent Application No. 63/609,091, filed Dec. 12, 2023, which is incorporated by reference herein in its entirety.

### BACKGROUND

Rotary propulsion systems for aircraft provide thrust by driven rotation of aerodynamic actuators. Such rotary actuators, variously referred to as propellers, rotors, propulsors, fans, or the like, often consist of airfoil-shaped blades attached to a hub, shaft, or frame drivingly connected to an associated engine or motor to rotate the blades at high speeds. Such propulsion systems often provide multiple rotors driven by dedicated engines or motors mounted at spaced locations on different portions of the airframe, such as on the front, rear, wings, tail, or other exterior surfaces of the aircraft. Rotary propulsion is commonly found on many types of aircraft including airplanes, helicopters, vertical takeoff and landing (VTOL) vehicles, unmanned aerial vehicles (UAVs), and others.

Operating risks of rotary propulsion include the possibility of imbalance events during operation. Imbalances can occur due to a number of causes, including mechanical wear, in-flight damage, environmental exposure, asymmetric loading, and component failures. Even minor imbalances at high rotary speeds can generate potentially damaging forces, vibrations, and/or control difficulties. In extreme cases, substantial propeller imbalances can produce loads and vibrations severe enough to cause premature fatigue and, potentially, mechanical failures. The onset of rotor imbalances poses an operational risk as they can often increase in severity owing to self-amplifying or cascading failure caused by excessive vibration.

Previous approaches for monitoring and mitigating rotary imbalance events in aircraft have primarily relied on manual inspection and maintenance procedures. These procedures typically involve visual inspections of the propulsion units and subjective assessments of their performance. However, these manual approaches are time-consuming, labor-intensive, often unreliable, and may not provide real-time feedback on the status of the propulsion units. Warning systems triggered in response to the measurement of excessive airframe vibration may indicate merely the possible occurrence of an out-of-balance event but do not enable effective mitigation responses other than an overly conservative system-wide power reduction or shutdown.

### BRIEF SUMMARY

The present disclosure includes systems and methods for detecting, identifying, and mitigating sources of vibration anomalies in multi-propulsor aircraft by operating a particular propulsion unit at a unique rotary speed relative to that of the other propulsion units, analyzing distributed vibration data for the aircraft, and identifying the particular propulsion unit as a source location of a vibration anomaly based on correspondence between the speed of the particular propulsion unit and a frequency at which the vibration anomaly presents in the vibration data. In some examples, the particular propulsion unit is additionally identified as being a source of the vibration anomaly (referred to in this description as an event engine (EE)) if the peak frequency of the vibration anomaly corresponds to a whole number or integer multiple of the unit's rotary speed.

Such event engine identification via frequency-domain vibration analysis is based on the observation that when a rotating component, such as a propeller or rotor, develops an imbalance, it induces vibrations into the supporting structure at frequencies related to its rotary speed. The primary vibration frequency is typically equal to the number of revolutions per second multiplied by the order of imbalance. For example, consider a propeller spinning at 1200 RPM, which equals 20 revolutions per second. If the propeller has a first-order imbalance, meaning the center of mass is offset from the rotational axis by a certain amount, it will induce a vibration at 1× the rotary speed, or 20 Hz, in this example. Higher-order imbalances produce vibrations at integer multiples of rotary speed. For example, a second-order imbalance generates a 2×vibration relative to the RPM. In summary, the source of the vibration rotates at a certain speed, and physics causes it to induce oscillations matching that speed. The specific frequencies of problematic vibrations are thus tied directly to the speed of the imbalanced component inducing such vibrations. This relationship allows vibration analysis to isolate the event engine.

Identifying the event engine via such frequency-domain analysis is challenging when more than one propulsion units operate at the same speed. In some examples, one of the propulsion units (referred to inter alia herein as the target unit, candidate unit, candidate event engine, or the like) is selected and operated at an adjusted speed, sufficiently offset from the baseline speed of the other propulsion units to allow for reliable sensing and detection. Vibration sensors monitor alternate locations on the aircraft for anomaly frequencies. If the vibration anomaly frequency shifts to match the speed of the adjusted propulsion unit, the adjusted propulsor is, in some examples, thereby identified or confirmed as the anomaly source.

If the selected target unit is not confirmed as being the event engine, a different propulsion unit is, in some examples, selected and operated at a stepped or adjusted speed, being confirmed as the event engine if the vibration anomaly undergoes a corresponding frequency shift. The system, in some examples, thus iteratively cycles through the propulsion units until a linked frequency shift in the vibration anomaly reveals which propulsion unit is responsible for an imbalance or malfunction. Once identified, the source propulsor is automatically managed by the system to mitigate the imbalance event while allowing continued operation of the remaining propulsors.

The disclosed techniques thus, in some examples, leverage deliberate speed perturbations or modulation combined with at least post-modulation frequency analysis to intelligently troubleshoot vibration issues in real-time while in-flight, thereby enabling automated identification of problematic propulsion units quickly and without the potential for human error.

Some aspects of the disclosure pertain to comparative automated vibration monitoring systems (CAVM) systems for the management of rotary imbalance risks through rapid automated detection, diagnosis, and mitigation of developing rotor failures during aircraft operation. A distributed network of vibration sensors enables continuous real-time monitoring of vibration spectra across multiple rotary propulsion units, including sufficiently-accurate time synchronization. Local processing algorithms analyze vibration data (e.g., amplitude, frequency, and phase) at each sensor, detecting anomalies indicative of rotor imbalances exceeding defined thresholds.

The CAVM system, in some examples, leverages frequency-domain analysis of vibration data to detect and diagnose hazardous rotor imbalances. Respective vibration signals are, in some examples, continuously captured at each propulsion unit, indicating cyclical motion experienced at each propulsion unit. In some such examples, time-domain waveforms are converted to the frequency domain using transforms such as the Fast Fourier Transform spectrum and/or Autopowers spectrum based on detection and validation preferences or implementation particulars, revealing the spectral content in terms of vibration amplitude as a function of frequency, in some examples considering phase if applicable. Instead, or in addition, order-domain data are, in some examples, extracted and included when compared to rotor azimuthal reference, such as a respective tachometer signal for each propulsor. Imbalance events induce excessive vibration energy at frequencies related to rotor speed. By analyzing the frequency spectrum, imbalances are detected as anomalous amplitude spikes at characteristic rotor frequencies.

In some examples, peer-to-peer communication between respective elements of the CAVM system allows collaborative assessment of vibration data across disparate sources to pinpoint the source of an imbalance event via frequency distribution of anomalous vibration(s) evidenced by the vibration data; pinpointing the imbalance event source based on frequency-domain analysis, including analysis of frequency, amplitude, and/or phase of vibration data. Additionally, some of the examples disclosed herein include frequency-domain extraction of the time-domain waveforms. It will be understood that such frequency-domain analysis can instead or in addition include the extension of rotor-order domain signals from this frequency-domain data, all functioning to provide reliable frequency, amplitude and phase information. As mentioned, diagnostic logic identifies an event engine based on frequency-domain analysis of the vibration anomaly. Note that the event engine is, in some examples, identified and verified based at least in part on the respective vibration signals at propulsion units other than the event unit, also referred to herein as off-target or sibling propulsion units.

To troubleshoot the source location, the system, in some examples, perturbs or modulates the rotor speed of a candidate engine, such that the candidate engine has a readily distinguishable post-modulation speed different from its pre-modulation speed. This causes its associated vibration center-frequency signature to shift up or down directly proportional to the rotor speed change. In some examples, a sequence of controlled RPM perturbations thus intelligently troubleshoots and validates the event engine based on comparative vibration response analysis. The system analyzes if this frequency shift is mirrored in the vibration spectra of other engines, indicating the perturbed engine as the imbalance source or event engine. This comparative frequency-domain analysis reliably identifies the event engine versus other engines.

In other examples, the system perturbs the rotor speed of multiple propulsors in parallel for identification of source location by analysis of resultant vibration data. In some such examples, a set of propulsion units are switched to operation at different rotor speeds, so that each of the propulsion units has a unique respective rotor speed. Frequency-domain analysis to identify the event engine can, in some such examples, comprise order-domain analysis, examples of which are discussed later herein.

According to some examples, once a candidate event engine is identified based on initial frequency analysis, the system performs further verification and validation to conclusively confirm the source of imbalance before executing final mitigation actions. The rotary speed of the candidate engine is, in some such examples, modulated through two or more perturbation values, and the vibration response is analyzed for confirmation. This controlled troubleshooting procedure verifies the event engine with high integrity before proceeding with mitigation procedures.

According to one example, a final validation check is automatically performed, in which the speed of the verified event engine is reduced and the vibration decay pattern analyzed across all engines for consistency, ensuring no other contributing sources remain before shutdown. Such a multi-stage verification and validation prevents false positives.

With the event engine confirmed, the system executes targeted mitigation actions tailored to the specific fault condition while allowing continued operation on remaining healthy engines. Example mitigation actions include throttling down the event engine RPM into a safe range and/or shutting down the engine entirely if necessary, including possible variations such as RPM reductions while also maintaining equivalent thrust levels for such propulsors with variable blade pitch control. This prevents failure of the event engine while avoiding unnecessary and potentially hazardous system-wide shutdown, whilst in some instances also allowing for possible partial use of a propulsor at alternate operating conditions where, for example, reduced rotor speeds sufficiently reduce imbalance to safe levels for continued operation.

Benefits of the disclosed methods, systems, and aircraft configured to provide the disclosed functionalities include rapid automated fault detection, intelligent diagnostic isolation, controlled troubleshooting, selective mitigation, continued safe operation, avoidance of false positives, and condition-based maintenance.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of an aircraft according to one example.

FIG. 2 is a block schematic diagram of an avionics system of an aircraft, according to one example.

FIG. 3 is a schematic diagram illustrating a system architecture of an aircraft having an avionics system such as that of FIG. 2, according to one example.

FIG. 4A is a flowchart illustrating broadly a method of automated control of an aircraft according to one example, including management of out-of-balance failure risks.

FIG. 4B is a flowchart illustrating broadly a method of automated control of an aircraft according to example implementations in which identification of an event unit causative of an imbalance event comprises controlled speed modification limited to a target propulsion unit selected automatically from a set of propulsion units.

FIG. 4C is a flowchart illustrating broadly a method of automated control of an aircraft according to example implementations in which identification of an event unit comprises controlled speed modification of a set of propulsion units such that each propulsion unit operates post-modulation at a unique or distinct respective rotary speed.

FIG. 5A-FIG. 5D are a series of flowcharts together illustrating in comparatively greater detail an example method of operating an aircraft according or analogous to one or more of the methods of FIG. 4A-4C.

FIG. 6A illustrates an example set of frequency-domain vibration signals for respective propulsion units of an aircraft at initial detection of a rotary imbalance event, according to one example.

FIG. 6B illustrates an example set of frequency-domain vibration signals corresponding to those of FIG. 6A but following RPM perturbation of a candidate event engine, according to one example.

FIG. 6C illustrates an example set of order-domain vibration signals corresponding to those of FIG. 6A but following RPM perturbation of multiple propulsor units to operate at mutually distinct respective rotary speeds, according to one example.

FIG. 7 illustrates a diagrammatic representation of a machine in the form of a computer system within which a set of instructions may be executed for causing the machine to perform any one or more of the methodologies discussed herein, according to some examples.

### DETAILED DESCRIPTION

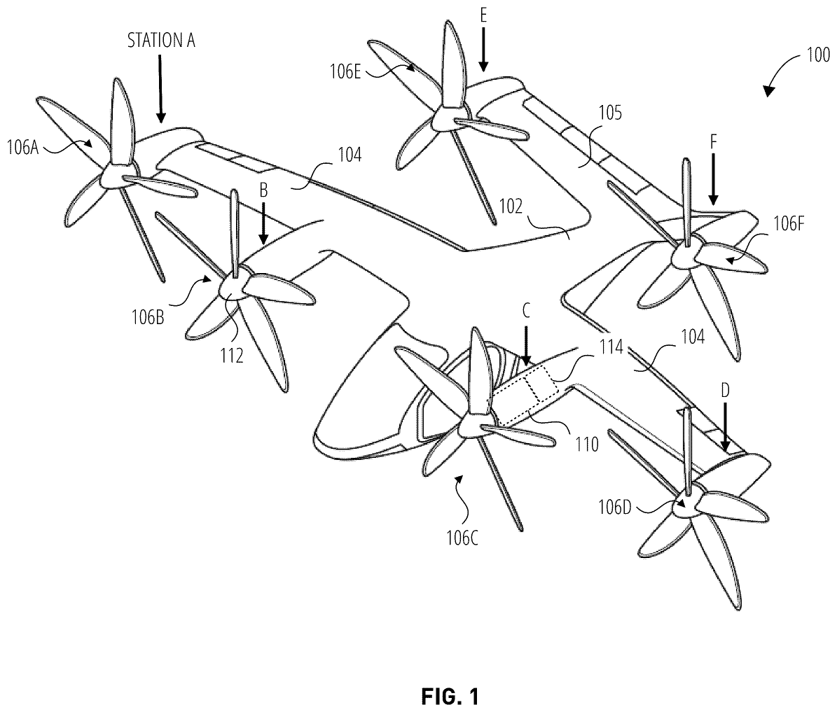

FIG. 1 is a schematic view of a multi-engine aircraft 100 with integrated onboard avionics that provides dynamic in-flight rotor fault diagnostics and mitigation functionalities according to one example. The aircraft 100 is in this example an electrically powered fixed-wing vertical take-off and landing (VTOL) vehicle but it is to be appreciated that such a configuration is one of many alternative aircraft types to which the disclosed techniques, mechanisms and systems are applicable and is thus to be understood as a non-limiting example as it pertains to its physical shape, configuration, and flight mechanics. It is to be understood that the electric battery powertrain can, in other examples, analogously be implemented with alternative types of powertrain architectures, such as a hydrogen fuel-cell powertrain architecture with or without electric batteries. It is likewise to be understood that the rotary fault detection and mitigation functionalities can, in other examples, analogously be implemented in conventionally powered aircraft, thus not being limited to electrically powered aircraft.

The aircraft 100 has an airframe that includes a fuselage 102, two wings 104, an empennage 105 and six propulsion units in the example form of electric propulsion units (EPUs 106) mounted at respective spatially distributed thrust stations on the wings 104 and empennage 105. For clarity of description, the thrust stations are labeled in FIG. 1 as stations A through F, with reference to any particular propulsion unit further herein being indicated by the appendage of the corresponding station's label. Thus, the propulsion unit at station A is referenced as EPU 106A, station B's propulsion unit as EPU 106B, etc.

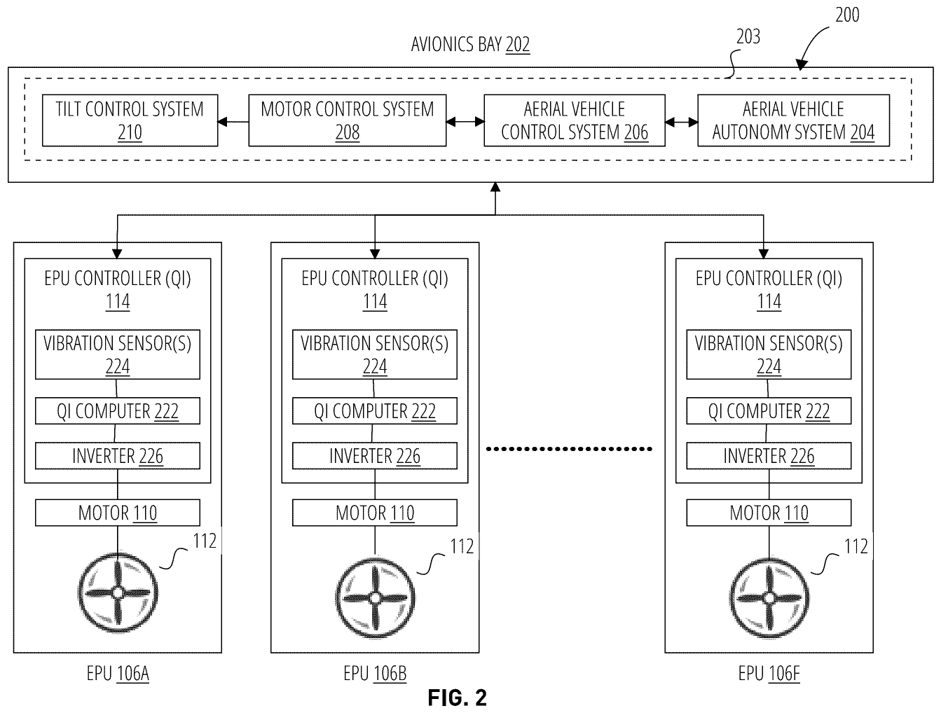

Each EPU 106, located at a respective station on the airframe, comprises an electric motor 110 and a rotor assembly 112 (in this example, respective propeller assemblies) that is in use rotationally driven by the associated motor 110. Each EPU 106 additionally comprises a respective computerized EPU controller 114 that performs computerized control of the motor using a quad inverter (QI), as described in more detail with reference to FIG. 2. The EPU controllers and their corresponding QIs are, for ease of reference, indicated and referred to herein also simply as QIs 114. Note also that the EPUs 106 of the illustrated example aircraft 100 are on occasion herein referred to as respective engines, and that the term “engine” in this context refers to an EPU holistically, including both its rotor assembly 112 and its electric motor 110. In some examples, the QI is included as a physical part of the EPU, in other examples being physically separate, and in yet further examples being physically distributed to be partially physically integrated with and partially physically separate from the motor.

The aircraft 100 further includes one or more power sources in the example form of battery packs (not shown) located at distributed locations in the airframe. The EPUs 106 are tiltable between vertical orientations for take-off/landing and horizontal positions in which thrust vectors are substantially horizontal, the wings 104 to generate lift to support the aircraft 100 during forward flight (as shown in FIG. 1). Further particulars of the propulsion and avionics of the example aircraft 100 are in some examples consistent with the corresponding descriptions in PCT application PCT/lJS2021/042205 for “ELECTRIC POWER SYSTEM ARCHITECTURE AND FAULT TOLERANT VTOL AIRCRAFT USING SAME,” filed on Jul. 19, 2021 and published as WO 2022/115132 on Jun. 2, 2022, which is hereby incorporated by reference herein in its entirety.

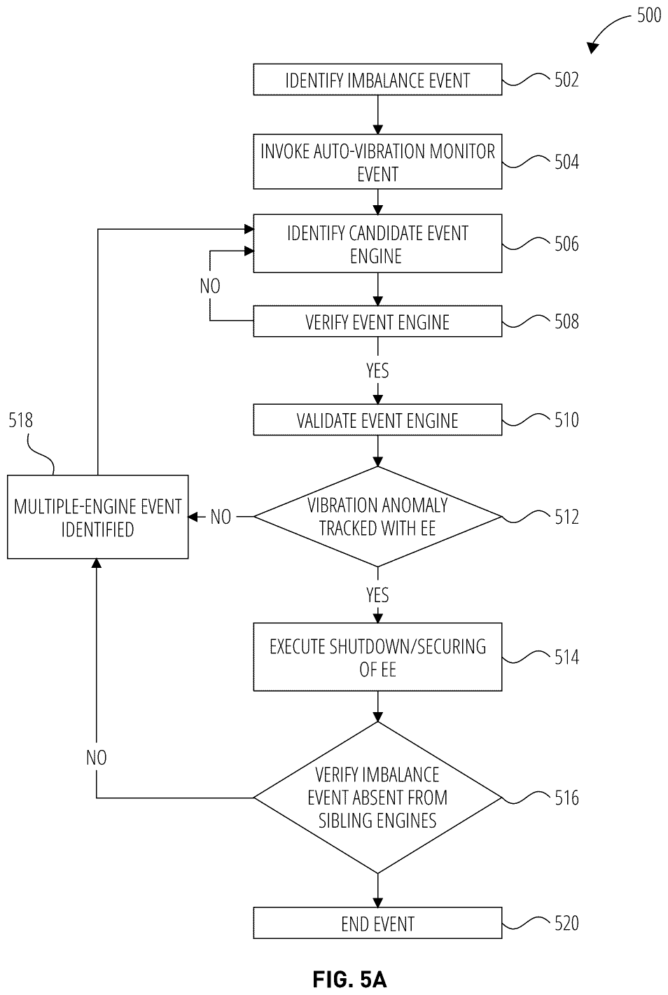

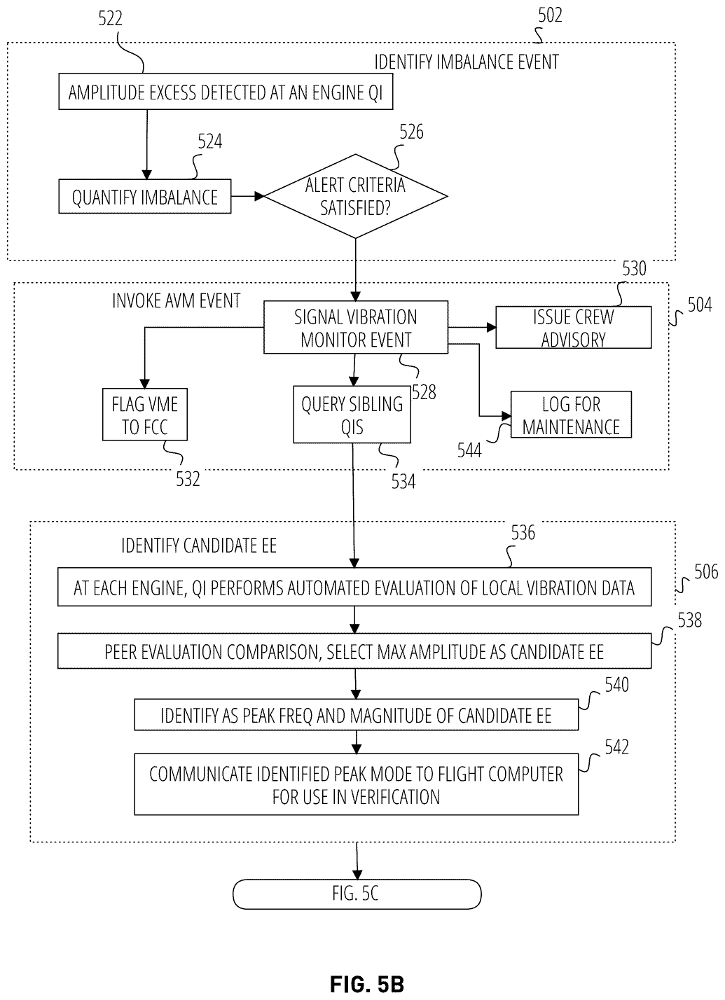

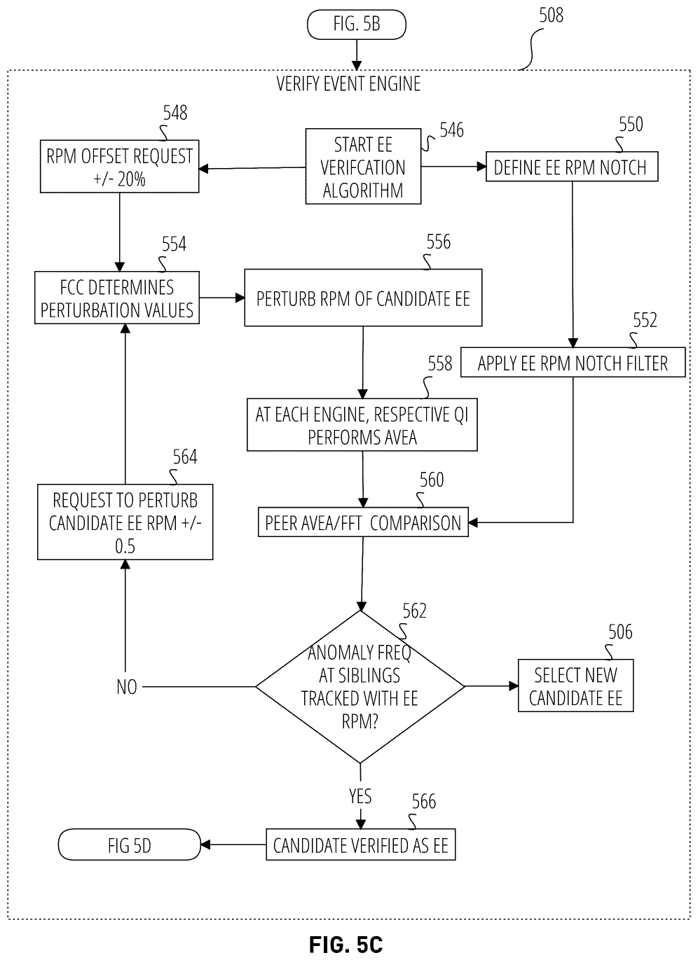

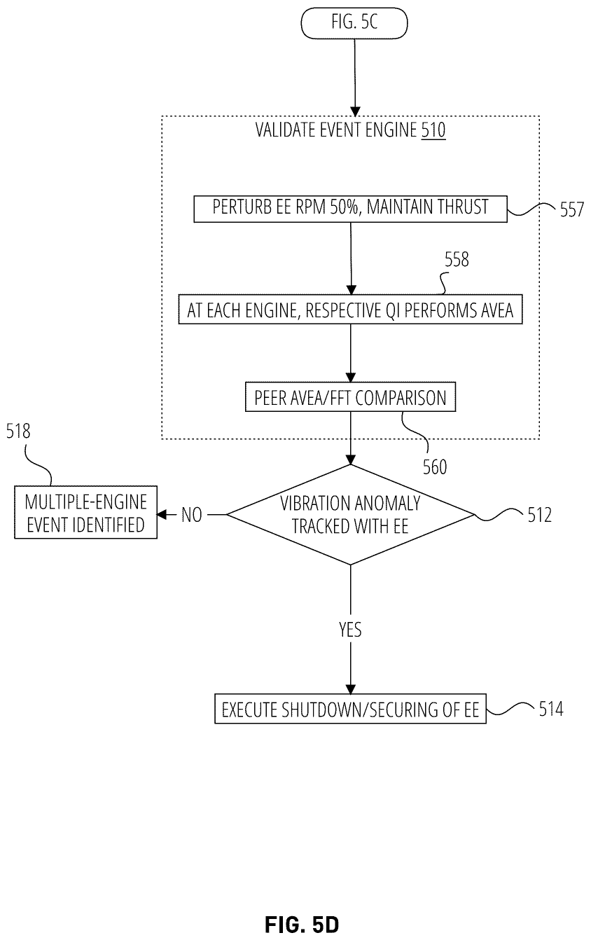

FIG. 2 is a block diagram illustrating an integrated avionics system 200 of the example aircraft 100 configured to provide dynamic in-flight detection and mitigation of propulsion out-of-balance events. The avionics system 200 includes an aerial vehicle control system 206, an aerial vehicle autonomy system 204, an electric motor control system 208 and tilt control system 210 located primarily within an avionics bay 202 of an aerial vehicle. In this example, these functionalities are described as being provided at least in part by a flight computer 203 in the avionics bay 202. As will be evident from the description of FIGS. 5A-5D, techniques for imbalance event management are in this example implemented cooperatively by the flight computer 203 together with the QIs 114 of the EPU 106.

As shown further in FIG. 2, the QI 114 of each EPU 106 includes a local processor system or controller in the example form of a QI computer 222 electrically coupled to one or more respective inverters 226 through which it drives the associated electric motor 110. Each QI computer 222 is communicatively coupled to the flight computer 203. Peer-to-peer communication is additionally enabled between the respective QI computers 222 via avionics bay 202.

Each EPU 106 further includes local vibration capture functionalities provided by one or more vibration sensors in the form of accelerometers 224 mounted at the respective thrust station. Each QI computer 222 is configured to continuously receive vibration data from its associated accelerometers 224, to process the vibration data in real-time to determine a frequency-domain vibration signal representative of vibration experienced at that thrust station, and to monitor the vibration signal for an imbalance event indicated by pre-defined threshold criteria.

The aerial vehicle autonomy system 204 is responsible for the autonomous or semiautonomous operation of an aerial vehicle and is communicatively coupled to conventional flight sensors of the aircraft, such as LIDAR sensors, radar sensors, and cameras, merely for example. The aerial vehicle autonomy system 204 is communicatively coupled to the primary aerial vehicle control system 206, which is, in turn, coupled to the various pitch, yaw, and throttle controllers of the aerial vehicle. Additionally, the aerial vehicle autonomy system 204 has access to the respective vibration signals captured by the distributed vibrations sensor system provided by the respective accelerometers 224 mounted at each of the EPU 106.

The aerial vehicle control system 206 is furthermore communicatively coupled to and controls a tilt control system 210. The tilt control system 210 is responsible for the tilting or rotation of wings 104 and/or various other components of the aerial vehicle in order to provide enhanced control and flight stability of the aerial vehicle, as well as the implementation of countermeasures to mitigate the impact of an imbalance event in the propulsion system or an electrical or component failure of the aerial vehicle. To this end, the tilt control system 210 is communicatively coupled to respective wing rotation mechanisms. The tilt control system 210 is configured to differentially tilt the wings 104 (and/or rotor assemblies 112 thereof) to generate moments or torques that tend to change the attitude of the aerial vehicle. For example, the tilt control system 210 may generate a change to the pitch of the aerial vehicle by tilting both wings 104 forward (towards the nose end of the aerial vehicle) or backward (towards the tail end of the vehicle). Similarly, the tilt control system 210 may generate a yaw and/or roll movement by differentially tilting the wings 104 (e.g., tilting one wing member forwards and the other wing backward).

In some examples, the aerial vehicle control system 206 is configured to mix the use of wing tilts and differential rotor speeds to generate an appropriate attitude and/or thrust vector for the aerial vehicle. The mix of motor winding and differential rotor speeds may be determined based on various factors including, for example, desired modes and/or goals of the aerial vehicle (e.g., fuel efficiency, optimum control response, noise minimization).

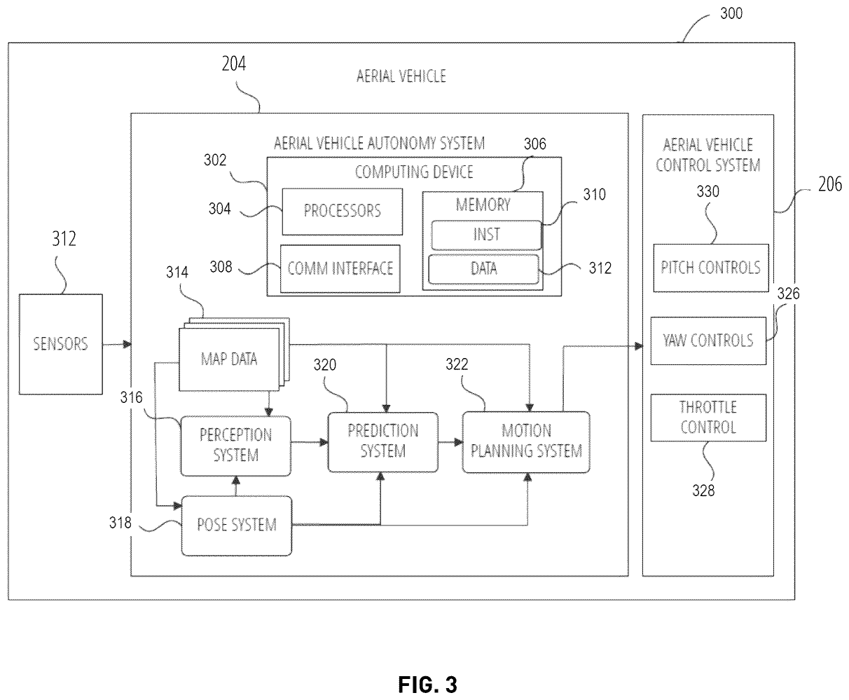

FIG. 3 is a block diagram showing the system architecture of an example aerial vehicle 300 (e.g., example aircraft 100 described above), according to example aspects of the present disclosure. The aerial vehicle 300 can be, for example, an autonomous or semi-autonomous aerial vehicle. The aerial vehicle 300 includes one or more sensors 312, an aerial vehicle autonomy system 204, and an aerial vehicle control system 206, such as those described above with reference to FIG. 2. In some examples, the aerial vehicle autonomy system 204 is provided by a flight control computer (see, e.g., flight computer 203 in FIG. 2) located in the avionics bay 202.

The aerial vehicle autonomy system 204 can be engaged to control the aerial vehicle 300 or to assist in controlling the aerial vehicle 300. In particular, the aerial vehicle autonomy system 204 receives vibration data from the sensors 312, attempts to comprehend the environment surrounding the aerial vehicle 300 by performing various processing techniques on data collected by the sensors 312, and generates an appropriate motion path through an environment. The aerial vehicle autonomy system 204 can control the aerial vehicle control system 206 to operate the aerial vehicle 300 according to the motion path. Such vibration data can include distributed vibration characteristics of an airframe of the vehicle, such as provided, for example, by respective accelerometers 224 at each EPU 106.

The aerial vehicle autonomy system 204 includes a perception system 316, a prediction system 320, a motion planning system 322, and a pose system 318 that cooperate to perceive the surrounding environment of the aerial vehicle 300 and determine a motion plan for controlling the motion of the aerial vehicle 300 accordingly.

Various portions of the aerial vehicle autonomy system 204 receive vibration data from the sensors 312. For example, sensors 312 may include remote-detection sensors as well as motion sensors such as an inertial measurement unit (IMU), one or more encoders, etc. The vibration data can include information that describes the location of objects within the surrounding environment of the aerial vehicle 300, information that describes the motion of the vehicle, etc.

The sensors 312 may also include one or more remote-detection sensors or sensor systems, such as a LIDAR, a RADAR, one or more cameras, etc. As one example, a LIDAR system of sensors 312 generates sensor data (e.g., remote-detection sensor data) that includes the location (e.g., in three-dimensional space relative to the LIDAR system) of a number of points that correspond to objects that have reflected a ranging laser. For example, the LIDAR system can measure distances by measuring the Time of flight (TOF) that it takes a short laser pulse to travel from the sensor to an object and back, calculating the distance from the known speed of light.

As another example, a RADAR system of sensors 312 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system can reflect off an object and return to a receiver of the RADAR system, giving information about the object's location and speed. Thus, a RADAR system can provide useful information about the current speed of an object.

As yet another example, one or more cameras of sensor 312 may generate sensor data (e.g., remote sensor data) including still or moving images. Various processing techniques (e.g., range imaging techniques such as, for example, structure from motion, structured light, stereo triangulation, and/or other techniques) can be performed to identify the location (e.g., in three-dimensional space relative to one or more cameras) of a number of points that correspond to objects that are depicted in image or images captured by the one or more cameras. Other sensor systems can identify the location of points that correspond to objects as well.

As another example, sensors 312 can include a positioning system. The positioning system can determine the current position of the aerial vehicle 300. The positioning system can be any device or circuitry for analyzing the position of the aerial vehicle 300. For example, the positioning system can determine a position by using one or more inertial sensors, a satellite positioning system such as a Global Positioning System (GPS), based on IP address, by using triangulation and/or proximity to network access points or other network components (e.g., cellular towers, WiFi access points) and/or other suitable techniques. The position of the aerial vehicle 300 can be used by various systems of the aerial vehicle autonomy system 204.

Thus, sensors 312 can be used to collect sensor data that includes information that describes the location (e.g., in three-dimensional space relative to the aerial vehicle 300) of points that correspond to objects within the surrounding environment of the aerial vehicle 300. In some implementations, sensors 312 can be located at various different locations on the aerial vehicle 300.

The pose system 318 receives some or all of the sensor data from sensors 312 and generates vehicle poses for the aerial vehicle 300. A vehicle pose describes the position (including altitude) and attitude of the vehicle. The position of the aerial vehicle 300 is a point in a three-dimensional space. In some examples, the position is described by values for a set of Cartesian coordinates, although any other suitable coordinate system may be used. The attitude of the aerial vehicle 300 generally describes the way in which the aerial vehicle 300 is oriented at its position. In some examples, attitude is described by a yaw about the vertical axis, a pitch about a first horizontal axis, and a roll about a second horizontal axis. In some examples, the pose system 318 generates vehicle poses periodically (e.g., every second, every half second) The pose system 318 appends time stamps to vehicle poses, where the time stamp for a pose indicates the point in time that is described by the pose. The pose system 318 generates vehicle poses by comparing sensor data (e.g., remote sensor data) to map data 314 describing the surrounding environment of the aerial vehicle 300.

The perception system 316 detects objects in the surrounding environment of the aerial vehicle 300 based on the sensor data, the map data 314, and/or vehicle poses provided by the pose system 318. The map data 314, for example, may provide detailed information about the surrounding environment of the aerial vehicle 300. The map data 314 can provide information regarding the identity and location of geographic places and entities, with specific details related to landing and take-off considerations (e.g., the location of pylons and other obstacles) The map data 314 may be used by the aerial vehicle autonomy system 204 in comprehending and perceiving its surrounding environment and its relationship thereto. The perception system 316 uses vehicle poses provided by the pose system 318 to place aerial vehicle 300 in the environment.

The motion planning system 322 can provide a motion plan to the aerial vehicle control system 206 to execute the motion plan. For example, the aerial vehicle control system 206 can include pitch control module 330, yaw control module 326, and a throttle control system 328, each of which can include various vehicle controls (e.g., actuators or other devices or motors that control power) to control the motion of the aerial vehicle 300. The various aerial vehicle control systems 206 can include one or more controllers, control devices, motors, and/or processors.

A throttle control system 328 is configured to receive all or part of the motion plan and generate a throttle command. The throttle command is provided to an engine and/or engine controller, or other propulsion system component to control the engine or other propulsion system of the aerial vehicle 300. A pitch control module 330 is configured to receive all or part of the motion plan and to generate one or more throttle commands and/or commands to the wing rotation mechanisms to modulate the pitch of the aerial vehicle 300. Similarly, a yaw control module 326 is configured to receive all or part of the motion plan and generate one or more throttle commands and/or commands to the wing rotation mechanisms, as described herein, to modulate the yaw of the aerial vehicle 300.

The aerial vehicle autonomy system 204 includes one or more computing devices, such as the computing device 302, which may implement all or parts of the perception system 316, the prediction system 320, the motion planning system 322, and/or the pose system 318. The example computing device 302 can include one or more processors 304 and one or more memory devices (collectively referred to as memory 306). Memory 306 includes instructions 310 for execution by the processors 304 and/or sensors 312 that can, for example, be acted upon by the processors 304. The processors 304 can be any suitable processing device (e.g., a processor core, a microprocessor, an Application Specific Integrated Circuit (ASIC), a Field Programmable Gate Array (FPGA), a microcontroller, etc.) and can be one processor or a plurality of processors that are operatively connected. The memory 306 can include one or more non-transitory computer-readable storage mediums, such as Random Access Memory (RAM), Read Only Memory (ROM), Electrically Erasable Programmable Read Only Memory (EEPROM), Erasable Programmable Read Only Memory (EPROM), flash memory devices, magnetic disks, etc., and combinations thereof. The computing device 302 can also include a communications interface 308, which can allow the computing device 302 to communicate with other components of the aerial vehicle 300 or external computing systems, such as via one or more wired or wireless networks. Additional descriptions of hardware and software configurations for computing devices, such as the computing device 302 are provided herein.

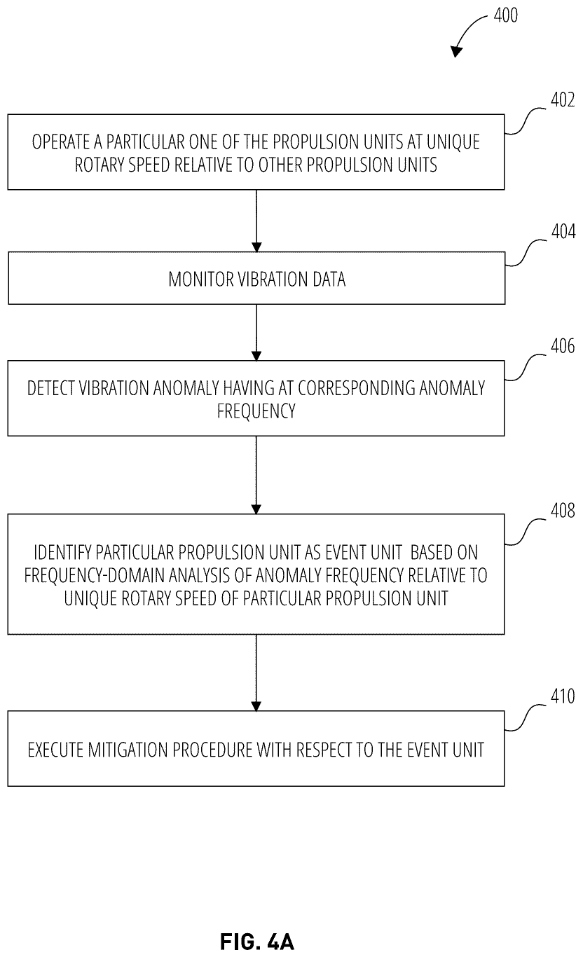

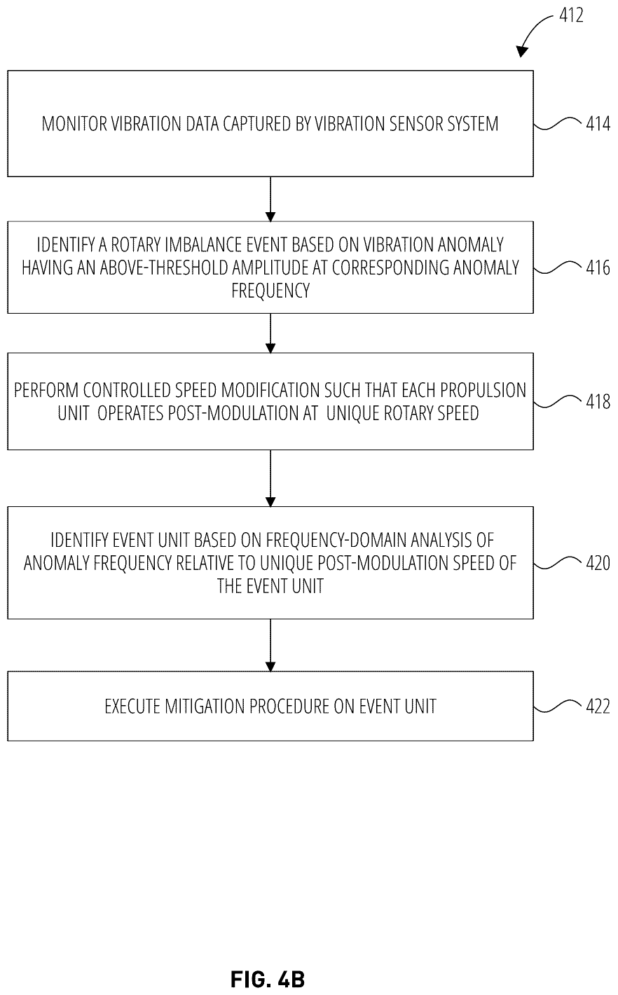

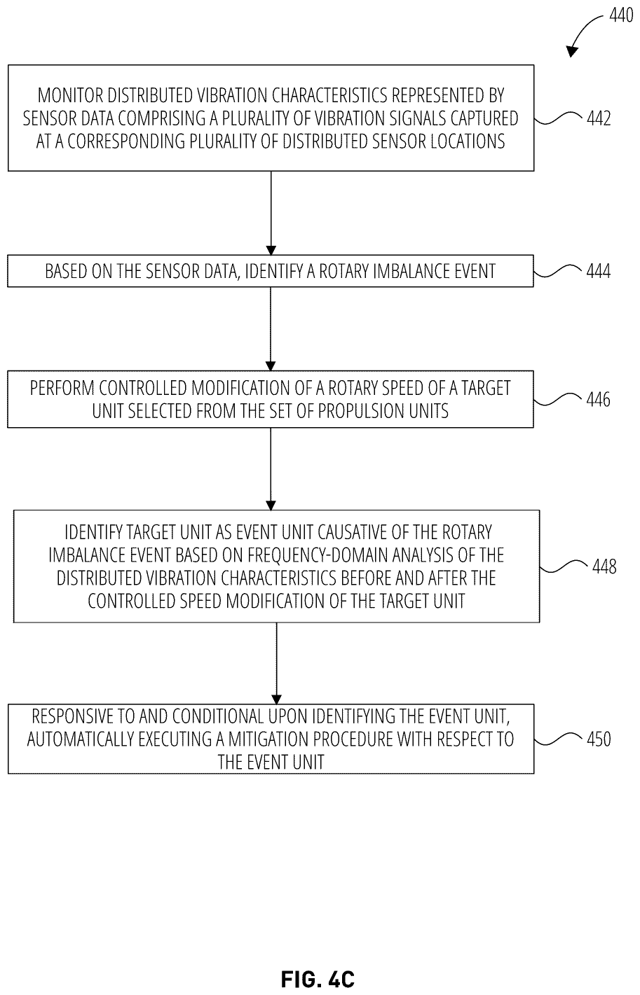

FIG. 4A illustrates a high-level process flow chart of a method 400 for detecting and mitigating rotor imbalance events using, for example, a Comparative Automated Vibration Monitoring (CAVM) system provided by the avionics system 200 of example aircraft 100, according to one example.

The method 400 is performed in-flight with respect to aircraft having a rotary propulsion system comprising a set of propulsion units (e.g., EPUs 106 of aircraft 100). At operation 402, method 400 comprises operating a particular one of the propulsion units (PUs) at a unique rotary speed relative to the respective rotary speeds of other PUs of aircraft. That particular PU is thus driven at a respective rotary speed distinct from any of the other PUs. In some examples, operation of at least one of the PUs at a respective unique or distinct speed (at operation 402) to facilitate identification from the set of PUs of an event engine (EE) causative of anomalous vibration(s) or imbalance event can be during regular or default operation, prior to or absent positive detection of an imbalance event. Thus, for example, each of the EPUs 106 of aircraft 100 can, in some example implementations, continuously run at distinct respective speeds. Such variegated-speed operation can be facilitated in an aircraft such as the example aircraft 100 by modulating other parameters such as thrust, rotor orientation, and/or blade angle to produce equivalent or balanced thrust despite varied rotor speeds.

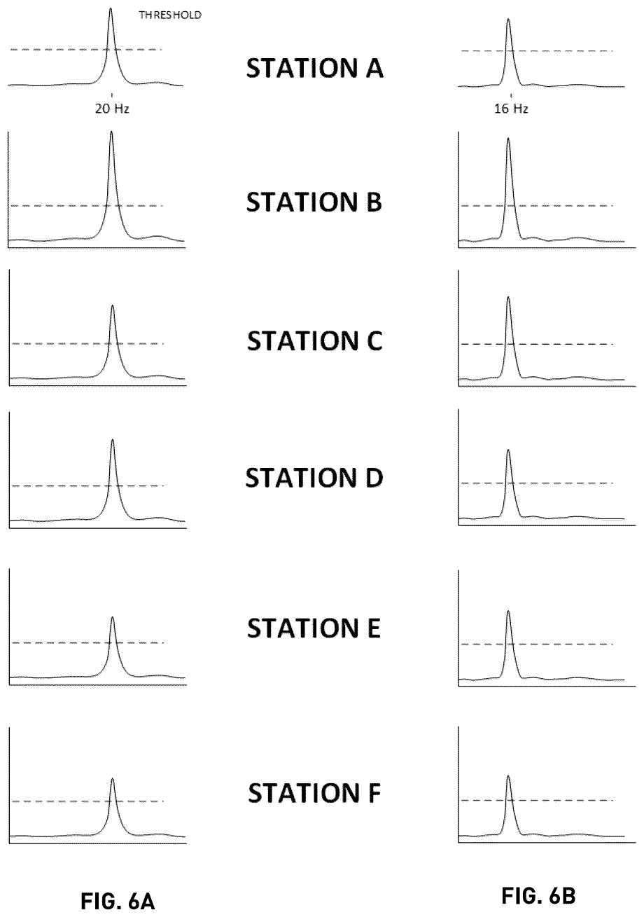

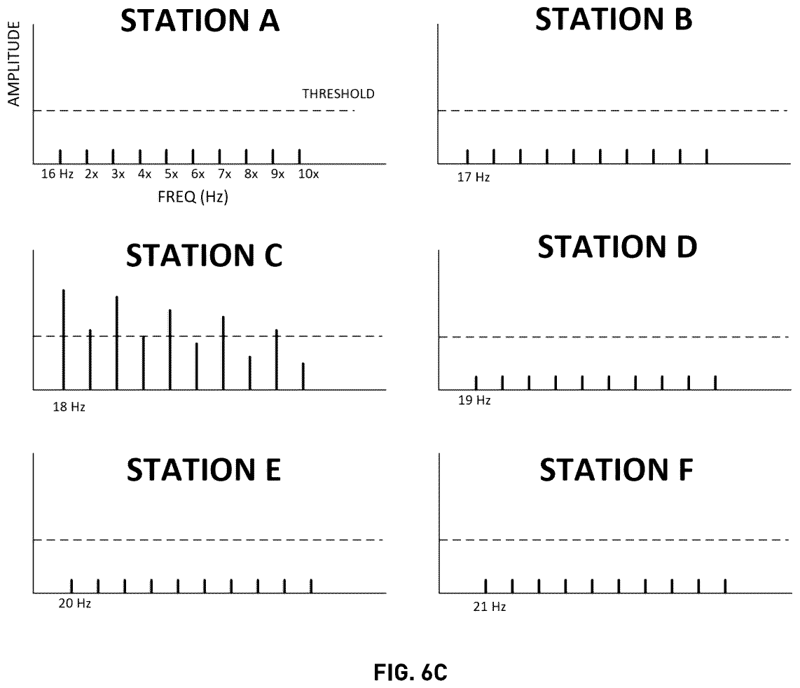

In other example implementations, however, such as those examples described below with respect to FIGS. 4B-6C, operation 402 results from controlled speed modification of one or more of the PUs, triggered by detection of anomalous vibration and/or an imbalance event. As will be discussed in greater detail below, FIGS. 4C and 6C illustrate examples in which detection of an imbalance event triggers controlled modification of the rotary speeds of the set of PUs (e.g., changing the speeds of all but one of the PUs in an example of identical pro-modulation speeds) such that each of the PUs is driven at a unique or distinct respective speed. In the example of aircraft 100, the six EPUs 106 would, in such an instance, operate at six different speeds. In contradistinction, FIGS. 4B and 5A-6B illustrate examples in which imbalance event detection triggers controlled speed modification of a single target unit at a time so that only the target unit operates in some instances operates at a unique speed relative to the other EPUs 106.

Returning now to FIG. 4A, at operation 404, vibration data captured by an integrated vibration sensor system is monitored, e.g., by the onboard avionics system 200 integrated with the aircraft. At operation 406, a vibration anomaly having an above-threshold amplitude is detected at a corresponding anomaly frequency. In some instances, the vibration data may indicate a number of above-threshold spikes or anomalies at different respective frequencies, e.g., comprising a series of above-threshold amplitude spikes at harmonic orders of a fundamental frequency.

At operation 408, in an automated operation processing the vibration data, said particular propulsion unit is identified as an event unit based on frequency-domain analysis of the anomaly frequency relative to the unique rotary speed of that particular propulsion unit. Identification of the event unit comprises identification via automated vibration data processing of a causative linkage between the rotary speed of the event unit and the specific frequency at which one or more vibration anomalies are present in the vibration data. As will be discussed at greater length below, such frequency-domain analysis can comprise identifying correlation in frequency between one or more above-threshold amplitude spikes in the vibration data and (a) the fundamental frequency corresponding to the unique rotary speed of the event unit, and/or (b) a harmonic of the fundamental frequency, e.g., at 2×, 3×, etc., of the fundamental frequency. Signal processing techniques for such frequency analysis comprise different suitable techniques in different implementations, including but not limited to methodologies such as Fast Fourier Transform (FFT) techniques, Spectrum techniques, Autopower techniques, and/or order domain analysis techniques.

At operation 410, responsive to and conditional upon identifying the event unit, a mitigation procedure is automatically executed with respect to the event unit. In some examples, such mitigation involves reducing the RPM of the event unit to prevent continued high-speed operation. In some instances, mitigation can comprise a full shut-down of the problem EPU 106. In other instances, the problem EPU 106 is operated at a reduced/modified RPM at which no above-threshold vibration is evidenced by the vibration data. In some cases of mitigation via continued operation at reduced/modified RPM, one or more other variables of the problem EPU 106 can be automatically adjusted such that the problem EPU 106 continues to produce the same thrust as prior to mitigation or in some cases produces reduced lift but levels greater than would result purely from RPM reduction. In particular instances, the mitigated EPU 106 can, for example, operate at reduced RPM but increased torque. Instead or in addition, rotor/blade attack angle, tilt, and/or orientation can automatically be adjusted to produce target thrust or suitable thrust for continued flight. In addition to the down-shifting or shutting down of the problem EPU 106, the operation of the remaining EPUs 106 is, in some examples, automatically controlled to compensate, e.g., by changing RPM, torque, tilt, orientation, or the like. Isolated mitigation on only the event unit, in some examples, avoids a broader system-level shutdown, which would have resulted from existing in-flight mitigation methodologies.

In some examples, the mitigation procedure instead or in addition comprises the generation and/or storage of a maintenance alert or notification. The system can in such examples be configured to identify an event engine or origin unit for anomalous vibration(s) that do not warrant or require in-flight speed reduction or similar immediate procedures for mitigation of failure, instead, for example, raising a maintenance notification or log entry flagging the identified EPU 106 for future maintenance attention and/or closer inspection.

Turning now to FIG. 4B, therein is illustrated a high-level process flow chart of a method 412 for detecting and mitigating rotor imbalance events using, for example, a Comparative Automated Vibration Monitoring (CAVM) system provided by the avionics system 200 of example aircraft 100, according to an example in which event engine identification includes controlled speed modification of one or more EPUs 106. At operation 414, the method 412 includes monitoring distributed vibration characteristics of the aircraft represented by vibration data comprising a plurality of vibration signals indicating cyclical motion experienced at a corresponding plurality of distributed sensor locations. In the example of FIGS. 1-3, for example, vibration characteristics are monitored across aircraft 100 using accelerometers 224 positioned at each EPU 106 to measure cyclical motion and generate vibration signals. This comprehensive vibration data provides a real-time picture of vibration levels across all EPUs 106 and their respective rotor assemblies 112.

At operation 416, a rotary imbalance event is identified based on the vibration data. In the foregoing example, the collected vibration data is analyzed by the QIs 114 to identify a rotor imbalance event. Amplitude and frequency anomalies in the vibration data indicate a potential rotor out-of-balance event, as will be described in greater detail below with reference to FIG. 5A-FIG. 5D.

Once an imbalance event is detected and/or logically declared, controlled modification of the rotary speed of a target unit (also referred to as candidate event engine or candidate unit) selected from the set of propulsion units is performed at operation 418. For example, controlled speed modification is made to a target EPU 106 by flight computer 203, which commands RPM perturbations via the QI 114 of the target EPU 106 while maintaining thrust levels. The target EPU 106 thus has a pre-modulation speed (RPM) and a post-modulation speed (RPM).

At operation 420, the target unit is identified as event unit causative of the rotary imbalance event based on comparative frequency-domain analysis of the distributed vibration characteristics before and after the controlled speed modification of the target unit. In the example of FIGS. 1-3, the target EPU 106 is identified as the source of the imbalance event by QI 114 using comparative frequency-domain analysis before and after the speed modulation by executing an Automated Vibration Evaluation Algorithm (AVEA) via the respective QI computers 222. The AVEA analyzes how the vibration characteristics change in response to RPM perturbation of the target or candidate EPU 106. The correlation of the vibration anomaly with the target EPU 106 RPM confirms it as the imbalance source. For example, identification of the target or candidate EPU 106 as event engine is indicated by the peak mode of an excess amplitude (being the frequency band of a vibration signal amplitude spike) at the EPU 106 other than the target EPU 106 tracking with or mirroring the post-modulation RPM of the candidate EPU 106.

At operation 422, responsive to and conditional upon identifying the event unit, a mitigation procedure is automatically executed with respect to the event unit. Thus, in the foregoing example, once the target EPU 106 is validated as the event engine, flight computer 203 performs automated mitigation to address the problematic EPU 106. The mitigation procedure in this example involves reducing the RPM of the target EPU 106 to prevent continued high-speed operation. In other examples, mitigation procedures can comprise alternative procedures such as those discussed above with reference to operation 410 in FIG.

In summary, this process executed by avionics system 200 allows rapid detection and mitigation of hazardous imbalances in rotor assemblies 112 by leveraging distributed vibration sensors (e.g., accelerometers 224) and comparative frequency analysis in response to controlled speed modification of a suspected event unit. The multi-phase approach provides robust validation of the source before executing automated corrective measures.

Turning now to a more detailed example consistent with the method described broadly with reference to FIG. 4B, FIGS. 5A-5D illustrate a more granular flowchart of an example method 500 for detecting and mitigating rotary imbalance events in the example aircraft 100 of FIGS. 1-3. The example method 500 is described as being autonomously implemented by a Comparative Automated Vibration Monitoring (CAVM) system provided by the example avionics system 200 of FIG. 2. FIG. 5A provides an overview of the method 500, with FIGS. 5B-5D showing more detailed flowcharts for respective portions of the flowchart of FIG. 5A.

As shown in FIG. 5A, the method begins at operation 502 by continuously monitoring distributed vibration characteristics of the aircraft 100 based on vibration data provided by the QI accelerometers 224 positioned at each Engine Propulsion Unit (EPU) 106 across aircraft 100. In this example, each QI computer 222 locally processes and analyses a respective vibration signal captured by the local accelerometers 224 at that particular EPU 106 location. At operation 502, the QIs 114 thus locally analyze the vibration frequency spectrum in real-time to detect potential imbalance events based on predefined alert criteria. In particular, each vibration signal is monitored in the frequency domain to identify imbalance events based on the existence of an amplitude threshold excess sustained at a particular frequency, which indicates a potential issue.

In this example, each QI 114 monitors for rotary out-of-balance events based on analysis of the locally captured vibration signal's frequency-domain spectrum, which indicates the distribution of signal power over frequency and is thus used to detect anomalies over background vibration levels. An imbalance event is identified when the spectrum amplitude exceeds a defined threshold at a particular frequency and is particularly related to the fundamental rotor frequency. Different amplitude thresholds can be predefined in different implementations according to designer preference or use case particulars. Example amplitude thresholds include but are not limited to:
Peak vibration amplitude above 0.5 g;
Peak vibration amplitude 50% greater than baseline vibration level; or
Peak vibration amplitude 50% greater than historical norms for a given flight condition.

It will be appreciated that different techniques for quantification and identification of above-threshold vibration amplitude can be employed in different implementations. In one such example, imbalance event detection is triggered when the power spectral density (PSD) of the vibration signal exceeds a predefined threshold at a given frequency.

To disregard transient vibrations that only briefly exceed amplitude thresholds (e.g., relatively brief anomalies caused by events such as impulses, bird strikes, turbulence, or the like), a persistence criterion is included in this example to avoid false positives. The alert criteria thus include both an amplitude criterion and a persistence criterion, requiring the identified amplitude excess to persist for a defined period before indicating an imbalance event. In this example, the vibration sensor of each EPU 106 measures acceleration across a range of frequencies and generates a time-domain vibration signal. A frequency-domain transformation is then applied to produce frequency-domain vibration signal data for analysis of frequency-specific components of the captured vibration signal. It will be appreciated by those skilled in the art that a number of alternative frequency-domain transformation and signal processing techniques or methodologies can be employed to these ends in different implementations. Suitable frequency-domain transformation techniques, for example, include but are not limited to methodologies such as Fast Fourier Transform (FFT) techniques, Spectrum techniques, and/or Autopowers techniques).

In the present example, the signal is segmented into blocks of data, and a Fast Fourier Transform (FFT) is applied to each block to determine the frequency content, consisting of amplitude at the fundamental rotor frequency along with phase information. The frequency-domain calculation takes the spectral output and computes the amplitude present at each frequency bin (window) over a defined frequency range. For example, if using 1 Hz frequency bins/windows from 0-100 Hz, the PSD would contain 101 power values showing the distribution of signal power over that frequency range. Example persistence threshold criteria that can be applied in different respective examples include:
Amplitude threshold exceeded for at least 10 consecutive seconds;
Amplitude threshold exceeded for at least 10% of a 60-second data block; or
Excess vibration amplitude persists across more than a threshold number of consecutive FFT windows.

The alert criteria can additionally include frequency-spectrum constraints, e.g., limiting identification of excess amplitudes to predefined intervals or bands, in some examples, more specifically, fundamental rotor rotational frequency and/or orders thereof. A frequency criterion for event identification can, for example, include that the vibration anomaly be present between 10-30 Hz (being a typical range for propeller tones). In the present example, imbalance event detection is limited to vibration anomalies that substantially match the relevant propeller passing frequency (e.g., 15 Hz for a 900 RPM propeller).

Turning briefly to FIG. 5B, it will be seen that the event identification operation 502 comprises, at operation 522, detecting an amplitude excess in the vibration signal captured at one of the EPUs 106. In an example instance of method 500, amplitude excess identification is performed by the QI 114 of station B so that EPU 106B is an originating or reporting engine for the rotary imbalance event. At operation 524, the QI 114 of EPU 106B quantifies the excess amplitude in its locally sourced vibration signal and, at operation 526, determines whether or not the predefined alert criteria for anomaly amplitude threshold, persistence threshold, and frequency constraint are satisfied. If so, a rotary imbalance event at the originating EPU 106B is positively identified.

In summary, each QI 114 continuously and in real-time locally analyzes a locally captured vibration signal to identify potential rotary imbalance events based on amplitude threshold excesses at particular frequencies that persist over time and exhibit PSD levels indicating anomalous vibration energy at the frequency. This provides robust imbalance detection while avoiding false positives. The distributed QI system architecture facilitates continuous real-time vibration monitoring at each EPU 106 location.

As shown broadly in FIG. 5A and in greater detail in FIG. 5B, once an imbalance event is detected at operation 502, an Automated Vibration Evaluation Algorithm (AVEA) is initiated (at operation 504), which in the example of FIG. 5B comprises, at operation 528, signaling from the originating engine (in this example EPU 106B) a Vibration Monitor Event (VME) by communicating a VME flag to the flight computer 203 (operation 532). This promptly communicates the anomaly to the central flight computer 203. The distributed system architecture allows the local QIs 114 to detect vibrational anomalies in real time. Triggering the VME flag enables rapid coordination between the QIs 114 and flight computer 203 to analyze and address the imbalance event via execution of the AVEA. The VME flag is a high-priority interrupt that prompts the automated response sequence to quantify, verify, and mitigate the imbalance. This rapid machine-to-machine coordination enables an immediate automated reaction to the threatening vibration.

The reporting QI 114 (in this example for ease of reference also referred to as QI 114B) additionally logs a maintenance required event (operation 544). This creates a record in the maintenance computer that technicians can reference after landing. The data logged includes the date, time, severity, and frequency characteristics of the detected imbalance. Further, the originating QI 114B at this stage also issues a crew advisory (operation 530) via a crew advisory system (CAS), cautioning pilots of the detected anomaly and initiation of the autonomous AVEA.

AVM event invocation thus, in this example, further comprises, at operation 534, querying the other EPUs 106 (referred to as sibling engines having respective sibling QIs 114) to inform them of the event and to request respective local vibration information for identifying a candidate event engine (operation 506). Querying the sibling QIs 114 serves several purposes. First, it prompts the sibling QIs 114 to increase their vibration monitoring sensitivity to assist in identifying the source of the vibration anomaly. It also causes the siblings QIs 114 to isolate and capture vibration data at the frequency reported by the originating QI 114B. This data will be used for further operations in the AVEA. In this example, the reporting QI 114B transmits the query over an avionics bus to the sibling QIs 114 in peer-to-peer communication. The query contains key information about the anomaly including the amplitude, frequency, and timing characteristics. It also identifies the reporting or originating EPU 106B.

On receiving the query, each sibling QI 114 configures its vibration monitoring system to operate in an augmented state. This may involve increasing sampling rates, applying narrowband filters around the reported anomaly frequency, or capturing additional waveform data. The synchronized data from all QIs 114 provides input to verify the true EE. The sibling QIs 114 immediately transmit an acknowledgment of the query back to the reporting QI 114B. This handshaking protocol ensures reliable coordination amongst the distributed QI 114 controllers. It allows the system to rapidly transition into the focused vibration monitoring state required to confirm the source location of the imbalance event.

Next, a candidate event engine (EE) or target EPU is identified (operation 506). FIG. 5B shows an example of the procedure for candidate EE identification in greater detail. In the present example, the EPU 106 with the maximum quantified vibration amplitude for the anomaly is identified as the candidate (EE) (operation 538). This is based on an assumption that the unit with the highest vibration levels is likely the source of the anomaly. In the present example, all of the EPUs 106 are initially operating at essentially the same RPM, so the peak frequency for a rotary imbalance at any of the EPUs 106 would likely be at the same corresponding frequency, which does not allow for identification of a candidate EE based on peak frequency discrimination. In other examples, a subset of EPUs 106 from which the candidate EE is selected can be limited to those EPUs 106 having an RPM corresponding to the peak mode of the detected vibration anomaly.

In the present example, however, candidate EE identification (operation 506, FIG. 5B) comprises that the QI computer 222 of each of the distributed QIs 114 performs automated evaluation of their respective local vibration data (operation 536). Thus, at each EPU 106 location, the resident QI 114 analyzes the frequency-domain characteristics of its locally captured vibration signal (operation 536). This involves computing the frequency-domain spectrum and applying digital filters tuned to isolate the specific frequency reported for the candidate EE. In another example implementation, this involves computing the frequency-domain spectrum in the absence of filters but using fundamental rotor frequency ordering.

Next, the QIs 114 engage in peer-to-peer communication to share their vibration data findings (operation 538). This data exchange allows each QI 114 to compare the vibration characteristics at its respective EPU 106 to those reported by the other QIs 114. Based on this comparative analysis, the QI 114 which reports the maximum vibration amplitude at the frequency of interest is automatically selected as candidate EE. FIG. 6A provides a set of frequency-domain vibration signals reported by the respective QIs 114 for each of thrust stations A-F in an example. Note that all of the QIs 114 reflect the reported vibration anomaly at substantially the same frequency but that the locally captured amplitude of the anomaly varies between the different stations. As can be seen in FIG. 6A, the vibration signal for station B is, in this example, the largest in amplitude, and EPU 106B is thus identified as candidate EE.

It will be appreciated that when an imbalance event occurs in a rotor system, it creates excessive vibration energy at frequencies related to the rotary speed of the problematic rotary component. This vibration originates at the location of the imbalance. Due to physical coupling between the distributed propulsion units (being mounted on a common airframe) and from excitation of the airframe itself, some of this vibration energy transfers through the structure to other areas and EPUs. However, vibration amplitudes generally decrease with distance from the source due to effects such as material damping (neglecting for the moment any potential structural dynamic amplification phenomenon). Therefore, the region closest to the originating imbalance can reasonably be expected in many cases to experience the highest vibration levels, before they have been attenuated by energy losses during transfer. Since each EPU 106 in this example has a dedicated vibration sensor, the one that measures the maximum amplitude at the anomaly frequency is, by default, initially identified as likely situated closest to the source. Note, however, that the location experiencing the largest amplitude for such a vibration anomaly is not necessarily, in all instances, actually the source of the rotary imbalance, referred to herein as the event engine (EE) or event unit. Structural resonances could, for example, potentially amplify vibrations in some areas. There are thus some scenarios where the assumption may not hold. For example, if vibration propagates efficiently along a structural path to a remote location. Nevertheless, the highest amplitude is in this example employed for first-pass identification of which of the EPUs 106 is closest in proximity to the point of origin of the anomaly.

Once candidate EE 106B is identified, the peak mode or frequency and amplitude of the vibration anomaly as recorded by candidate EE 106B is confirmed (operation 540) and transmitted to flight computer 203 (operation 542). This cues the flight computer 203 to proceed with verification of the event engine (operation 506, FIG. 5A) verified isolation and mitigation actions for the confirmed problematic engine.

As illustrated broadly in FIG. 5A and shown in greater detail in FIG. 5C, once candidate EE 106B has been identified in operation 506, the QI 114B of candidate EE 106B initiates an EE verification procedure (operation 546) before executing mitigation procedures. The QI 114B communicates an RPM offset request (operation 548) to the flight computer 203, e.g., to offset the pre-modulation speed of the candidate EE 106B by 20%. In operation 554, flight computer 203 calculates appropriate RPM perturbation values to apply to the candidate EE 106B for verification purposes. The perturbation values are determined based on various factors, including, for example:
The current steady-state RPM (referred to herein also as the pre-modulation speed) of the candidate EE is taken into account. The perturbations are calculated as offsets from the existing RPM.
The bandwidth of the RPM modulation is predefined to be sufficient to conclusively determine correlation. In one example, the flight computer 203 perturbs the RPM by +/−20% from the original value, commensurate with the frequency-domain transformation specifics, their associated tolerance proportional to RPM, and the ability to accurately detect and/or to move away from structural airframe resonances.
Operating constraints are considered so that the RPM modulation does not also allow for exceedance of allowable RPM limits. Flight computer 203 contains control logic preventing commands outside of acceptable bounds or within predefined excluded frequency ranges. Some frequencies, for example, may correspond with resonant frequencies of structural components of the aircraft and are thus excluded from consideration.
Thrust levels are maintained by the flight computer 203 during RPM modulation for verification and/or validation. Compensation factors are applied to engine power settings, propeller tilt or angle of attack, etc., to attempt to maintain thrust.

In summary, flight computer 203 calculates optimized RPM perturbation parameters tailored to the specific operating conditions and constraints. This allows the system to validate the candidate EE 106B as the source while avoiding any issues. At operation 556, the flight computer 203 perturbs the RPM up or down around the pre-modulation speed of the candidate EE 106B, corresponding to the reported peak frequency of the vibration anomaly, varying it in this example by around +/−20%. In the present example, the original pre-modulation speed of the candidate EE 106B is 1200 RPM, corresponding to a frequency of 20 Hz at which the vibration anomaly was originally detected (see FIG. 6A). Rotary speed of the candidate EE 106B is in the verification procedure decreased to 960 RPM, corresponding to a 16 Hz frequency.

The candidate EE's QI 114B defines (at operation 550) and applies (at operation 552) an RPM notch filter to isolate the frequency of interest. This focuses the vibration monitoring to best detect response at the frequency of interest.

The sibling QIs 114 at other EPUs 106 (also referred to as off-target propulsion units, having respective off-target vibration signals) continue vibration monitoring, tracking whether the anomaly frequency shifts in correlation with the candidate EE RPM changes (operation 558). The QIs 114 have peer-to-peer communication, allowing comparison of findings. The QIs 114 analyze if the vibration peak moves up or down in frequency with the EE RPM perturbations (operation 560). The QIs 114 perform real-time frequency analysis, such as computing power spectral densities, narrowband tracking filters and/or order-domain analysis.

If the vibration anomaly tracks the RPM changes, this conclusively verifies the candidate EE as event engine (operation 566), i.e., as being the EPU 106 causative of the imbalance event and thus being the source (operation 564). This is because the anomalous vibration will shift frequency in sync if the candidate EE 106B is causing the imbalance; because an out-of-balance component rotated at a particular RPM tends to cause a vibration anomaly at a frequency corresponding to the RPM. See in this regard, for example, the respective vibration signal FFT graphs of the sibling QIs 114 after RPM perturbation of the candidate EE 106B, shown in FIG. 6B. Note that the above-threshold vibration anomaly now manifests at the sibling QIs 114 at or about 16 Hz, corresponding to the post-modulation speed of the candidate EE 106B. Thus, in the example represented by FIG. 6B, the frequency of the vibration anomaly in each of the sibling QI vibration signals tracks with the post-modulation speed of the candidate EE 106B.

Once the candidate EE 106B is verified as indeed being the event engine, confirmation thereof is transmitted to the flight computer 203 (operation 566). This prompts the flight computer 203 to proceed with validated isolation and mitigation actions specifically for the now confirmed problematic engine.

If, however, verification of the EE fails after perturbation in a first iteration, at operation 562, a request is sent to the flight computer 203 by the candidate EE QI 114 (operation 564) to perturb the RPM of the candidate EE 106B to a greater degree, to change the EE RPM to a different, second modulated speed. In this example, the second flight computer 203 in the second iteration of perturbation and tracking changes the speed of the candidate EE 106B upwards by 50%, in this example setting a second modulated speed of 1440 RPM, which corresponds to a frequency of 24 Hz. Operations 558 and 560 for automated vibration event analysis by the QIs 114 cooperatively are then repeated for the second modulated speed. Again, if the peak mode of the vibration anomaly captured at the sibling QIs 114 tracks with the perturbed speed of candidate EE 106B (in this case presenting in respective vibration signals within a narrow band about 24 Hz), then the candidate EE 106B is verified as being the event engine.

If, however, the anomaly frequency is also in the second iteration of the perturbation-frequency tracking sequence determined not to satisfy predefined verification criteria with respect to the perturbation frequency, it is determined that the candidate EE 106B is not in fact the event engine, and a different one of the EPUs 106 are selected as a new candidate EE. As seen in FIG. 5A, candidate EE selection (operation 506) and verification (operation 508) are iteratively repeated until positive verification of one of the EPUs 106 as event engine is obtained. In this example, candidate EEs are selected in order of descending peak amplitude in its local vibration signal for the vibration anomaly.

After verification of the target or candidate EE 106B as being the source of the imbalance event (operation 508), the event engine is validated (procedure 510, as shown broadly in FIG. 5A and in greater granularity in FIG. 5D) and a mitigation procedure is executed by shutting down or securing (operation 514) of the EE, in this example EPU 106B. This phase of the method 500 involves safely and reliably taking the confirmed faulty EPU 106 offline to prevent continued high-speed operation.

Procedure 510 for validating the event engine comprises, at operation 557, again perturbing the rotary speed of the verified event engine, EPU 106B, in this example by decreasing its speed by 50%. At operation 558, each QI 114, as before, performs the previously described Automated Vibration Evaluation Algorithm (AVEA) to monitor the vibration signal captured by the local accelerometers 224 and, at operation 560, performing peer comparison of evaluation results or frequency domain vibration signals. As the verified EE RPM is reduced, the amplitude of the anomaly in the vibration data across all stations decreases.

If, at operation 512, it is determined that the vibration anomaly tracked in frequency with the RPM perturbation for the validation process, then shutdown or securing of the event EPU 106B is performed, at operation 514. If, however, the vibration anomaly does not track in frequency with the perturbed RPM of the validation operation, then a multiple-engine event is identified at operation 518, and the automated vibration monitoring event is restarted at operation 504 with respect to the EPUs 106 other than the verified event EPU 106B. Such a multiple-engine event can occur due to cascading damage or debris affecting multiple units, resulting in more than one of the EPUs 106 contributing to above-threshold vibration anomalies. Although the EPU 106B was thus correctly identified as being at least in part causative or contributive of the detected out-of-balance event, further evaluation is required to identify which of the remaining EPUs 106 are additionally causing above-threshold vibration.

At operation 514, with a single verified EE present, shutdown procedures are initiated to reduce the RPM of the verified event unit, EPU 106B. This is achieved by the flight computer 203 transmitting appropriate commands to the QI 114B, which ramps down the engine speed. The rate of descent is controlled to avoid sudden changes in loading. Thrust levels are correspondingly decreased to maintain stability.

The AVEA facilities provided by the respective QI computers 222 track this decay and verify that the imbalance signature fades away as expected with the decreasing RPM of the confirmed event engine, EPU 106B. A check is performed at decision operation 516 to confirm the vibration levels for the imbalance event have dropped across all other sibling EPUs 106 as the EE is shut down. If the high vibration characteristic of the initial anomaly persists, that indicates additional EEs remain operational that were not identified in the original detection phase. This could be due to cascading failures arising during the process.

If residual high vibration levels are measured, the method 500 proceeds to operation 518, which restarts the AVEA routine at operation 506. This re-initiates the automated imbalance detection process described previously. Any additional EEs contributing to the sustained anomalous vibration will iteratively be identified and isolated using the Comparative Automated Vibration Monitoring (CAVM) system and techniques as described. The vibration detection and mitigation system integrated with the aircraft 100 will thus cycle iteratively through the remaining EPUs 106 until one or more additional event engines are identified and secured. In this example, the next candidate event engine is, at operation 506 of each iteration of the procedure, selected in order of descending vibration amplitude of the remaining anomaly at its peak frequency, analogous to the operations by which the initial candidate EE 106B is selected per the description above.

Once all EEs exhibiting the problematic imbalance signature have been individually identified and shut down, the vibration levels decay to normal operational levels across the aircraft 100. This is detected at operation 516 when predefined mitigation criteria are finally satisfied, indicating successful removal of all sources of the imbalance. At operation 520, with all above-threshold anomalous vibrations eliminated, the event is concluded. The crew is notified that the automated recovery process has been completed. The aircraft 100 can proceed with caution using the remaining functioning EPUS 106. The affected units flagged by the system are marked for maintenance.

The automated shutdown and securing procedure enabled by the CAVM functionalities, as described, provides controlled isolation of the specific propulsion unit exhibiting the rotary imbalance vibration anomaly. The system verifies resolution of the anomaly and rechecks for any subsequent issues arising. This can, in some instances, achieve effective mitigation while avoiding unnecessary system-wide shutdown that would typically have resulted in the absence of the disclosed ability to rapidly and in-flight detect the source of an out-of-balance event.

Returning now to FIG. 4C, therein is illustrated a high-level process flow chart, analogous to that of FIG. 4B, of a method 440 for detecting and mitigating rotor imbalance events using, for example, a Comparative Automated Vibration Monitoring (CAVM) system provided by the avionics system 200 of example aircraft 100, according to an example in which event engine identification includes synchronous controlled speed modification of the set of propulsion units so that each of the propulsion units rotate at a respective speed distinct from that of any of the other propulsion units of the aircraft. Differently defined, the speeds of a plurality of the EPUs 106 are modified responsive to event detection such that no two EPUs 106 are run post modulation at the same or closely similar speeds (i.e., at speeds insufficiently spaced to permit effective disambiguation of causally linked vibration phenomena reflected in resultant vibration data).

At operation 442 (corresponding to operation 414 in FIG. 4B), method 440 includes monitoring vibration data of the aircraft represented by vibration data, for example, comprising a plurality of vibration signals indicating cyclical motion experienced at the respective EPUs 106 similar to that described previously. At operation 444, a rotary imbalance event is identified based on the vibration data in a manner similar or analogous to that described with reference to operation 416 in FIG. 4B.

Once an imbalance event is detected and/or logically declared, controlled modification of the set of propulsion units is performed at operation 446, such that each propulsion unit operates post-modulation at a respective unique or distinct rotary speed. For example, in an instance where all six EPUs 106 initially run at the same or closely similar speeds, controlled speed modification is made to at least five of the EPUs 106 by flight computer 203, which commands RPM perturbations via the QI 114 of the respective EPUs 106 while maintaining thrust levels. The post-modulation speeds are thus spaced sufficiently to permit reliable disambiguation of respective causally linked vibration signals in the vibration data. In the present example, the post-modulation rotary speeds of the EPUs 106 are regularly spaced at intervals of 60 RPM, corresponding to 1 Hz intervals on a frequency-domain signal graph such as that of FIGS. 6A-6C.

At operation 448 (analogous to operation 420 of FIG. 4B), the event unit or event engine (EE) causative of the rotary imbalance event is identified based on frequency-domain analysis of the vibration data after the controlled speed modification of propulsion units. In this example, the EE is identified by identifying that one or more above-threshold vibration signal anomalies or spikes are present in the post-modulation vibration data at respective frequencies corresponding to the fundamental frequency of a specific EPU 106 and/or higher order harmonic frequencies of the fundamental rotor frequency. It will be appreciated that such frequency-domain analysis can, in different implementations, comprise different suitable signal processing techniques as described previously. Moreover, the operations regarding event engine identification, verification, and mitigation as described with reference to FIG. 4B and FIGS. 5A-5D can, in some examples, be applied, mutatis mutandis, in the execution of method 440, with a major distinction that perturbation of rotor speed corresponding to operation 556 comprises simultaneous or overlapping perturbation of a plurality of the EPUs 106 to operate at mutually distinct post-modulation speeds.

In this example, frequency-domain analysis of the vibration data comprises order domain analysis. Such order domain analysis comprises, for example, transforming vibration signals to the frequency domain and analyzing the spectral content at harmonics related to rotor speed. Specifically, the system monitors, for each EPU 106 a respective tachometer signal that provides real-time or near-instantaneous rotational speed data for a propulsor. This allows for determining the precise frequency at which a particular propulsor is rotating at each moment. However, rather than analyzing the entire broadband spectrum, filters are applied to isolate narrow frequency bands centered at harmonics (orders) of each propulsor's rotational speed. For example, if a propulsor is rotating at 800 RPM (13.33 Hz), the vibration data would be filtered to analyze the 1st order band centered at 13.33 Hz, the 2nd order band centered at 26.66 Hz, the 3rd order band at 40 Hz, and so on. This reveals vibration amplitude as a function of order. Imbalances or anomalies regularly generate high vibration energy at its orders related to RPM.

To facilitate order-domain analysis, each QI 114 in this example includes a respective tachometer which produces a respective tach signal for the associated propulsor. FIG. 6C provides a set of order-domain vibration signals reported post-modulation by the respective QIs 114 for each of thrust stations A-F in an example. B is, in this example, the largest in amplitude, and EPU 106B is thus identified as candidate EE. Note that each vibration signal comprises 10 narrow-band vibration amplitudes measured respectively at a fundamental frequency corresponding to the rotary speed of the associated EPU 106 as well as at each order of the fundamental frequency, up to its 10^{th} order. Different numbers of orders can be included in such analysis in different implementations.

Automated processing of the vibration data of FIG. 6C identifies EPU 106C as the event engine based on its being an order-domain vibration signal having above-threshold amplitudes at one or more of the fundamental rotor frequencies and/or its orders. It will be seen in this instance that Station C reports above-threshold amplitudes at its 1^{st}, 2^{nd}, 3^{rd}, 5^{th}, 7^{th}, and 9^{th} orders. Persons of ordinary skill in the art will appreciate that such odd-numbered distribution is typically indicative of dynamic imbalance caused by unequal mass distribution radially and axially.

At operation 450, responsive to and conditional upon identifying the event unit, a mitigation procedure is automatically executed with respect to the event unit, corresponding to that described with reference to operation 422 in FIG. 4B as well as FIGS. 5A-5D.

It will thus be seen that the disclosed techniques and systems for autonomous rotary imbalance detection and mitigation (e.g., the example CAVM-implementing system as described) provide a number of significant benefits for managing the risk of hazardous rotor imbalance events during flight operations.
One benefit is extremely rapid automated detection of potential rotor failures or blade damage. By continuously monitoring vibration spectra using the distributed vibration sensor network (e.g., damaging imbalance conditions are recognized within milliseconds of onset.
The system provides smart verification logic to validate the true problematic propulsion unit. Targeted troubleshooting via controlled RPM perturbations reliably identifies the source of imbalance. This prevents unnecessary system-wide shutdown of properly functioning rotors.
A multi-stage verification approach also ensures high-integrity identification of the event engine. False positives are avoided which could otherwise trigger incorrect mitigation responses. This enhances safety.
Focused mitigation only on the verified faulty unit allows the partial operation to continue using remaining healthy rotors, thus facilitating safer recovery or continued flight.
Finally, the modular open architecture scales across varying airframe configurations. Distributed sensing and processing are adaptable to fleets of any size.

It will further be seen that some examples of the disclosure leverage distributed QI vibration sensors and AVEA algorithms to detect, identify, verify, and mitigate rotor imbalance events through targeted RPM perturbations and isolation of the problematic EPU via frequency-domain analysis of changes to distributed vibration characteristics resulting from the targeted RPM perturbations. A number of benefits are provided by implementation of the disclosed techniques cooperatively via respective processors (e.g., QI computers 222) incorporated in or associated with respective propulsion units.
For example, the distributed network of propulsion unit controllers (e.g., QIs 114) enables continuous, real-time vibration monitoring simultaneously across all propulsion units (EPUs) 106. This comprehensive sensor coverage ensures no imbalance events are missed.
Each QI 114 has dedicated computing resources for local vibration data analysis. This avoids latency and bandwidth bottlenecks associated with centralized analysis. The QIs 114 can respond more rapidly to vibration changes.
Localized algorithms in the QIs 114 provide redundancy. If one QI 114 fails, the others continue imbalance detection unimpaired. There is no single point of failure.
Peer-to-peer communication between QIs 114 allows collaborative decision-making, such as selecting the candidate event engine based on relative vibration levels. The QIs 114 work as an ensemble.
The modular QI 114 architecture scales seamlessly as additional propulsion units are added to the aircraft 100. The network detects imbalances across any number of propulsion units in a multi-engine vehicle.

In summary, the distributed sensing, processing, and communications architecture of the QI 114 framework provides robust, reliable imbalance detection across a set of propulsion units. Redundancy is built-in at multiple levels.

### Machine Architecture

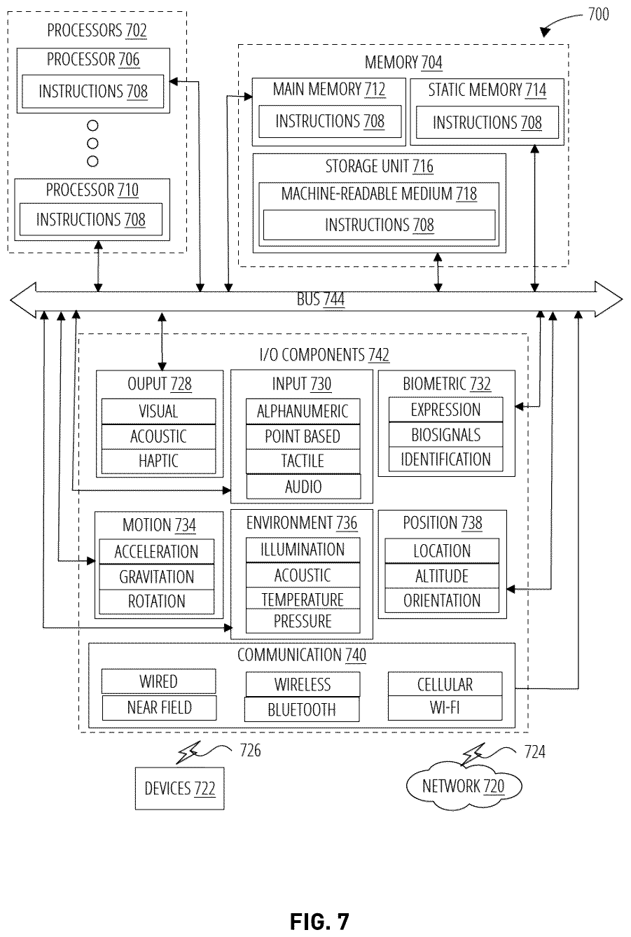

FIG. 7 illustrates a diagrammatic representation of a machine 700 in the form of a computer system within which a set of instructions may be executed for causing the machine to perform any one or more of the methodologies discussed herein, according to an example. For example, aerial vehicle control system 206 may be embodied as machine 700.

Specifically, FIG. 7 shows a diagrammatic representation of the machine 700 in the example form of a computer system, within which instructions 708 (e.g., software, a program, an application, an applet, an app, or other executable code) for causing the machine 700 to perform any one or more of the methodologies discussed herein may be executed. The instructions 708 transform the general, non-programmed machine 700 into a particular machine 700 programmed to carry out the described and illustrated functions in the manner described. In alternative examples, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is illustrated, the term “machine” shall also be taken to include a collection of machines 700 that individually or jointly execute the instructions 708 to perform any one or more of the methodologies discussed herein.

The machine 700 may include processors 702, memory 704, and I/O components 742, which may be configured to communicate with each other such as via a bus 744. In an example, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 706 and a processor 710 that may execute the instructions 708. The term “processor” is intended to include multi-core processors that may comprise two or more independent processors (sometimes referred to as “cores”) that may execute instructions contemporaneously. Although FIG. 7 shows multiple processors 702, the machine 700 may include a single processor with a single core, a single processor with multiple cores (e.g., a multi-core processor), multiple processors with a single core, multiple processors with multiples cores, or any combination thereof.

The memory 704 may include a main memory 712, a static memory 714, and a storage unit 716, both accessible to the processors 702 such as via the bus 744. The main memory 704, the static memory 714, and storage unit 716 store the instructions 708 embodying any one or more of the methodologies or functions described herein. The instructions 708 may also reside, completely or partially, within the main memory 712, within the static memory 714, within machine-readable medium 718 within the storage unit 716, within at least one of the processors 702 (e.g., within the processor's cache memory), or any suitable combination thereof, during execution thereof by the machine 700.

The I/O components 742 may include a wide variety of components to receive input, provide output, produce output, transmit information, exchange information, capture measurements, and so on. The specific I/O components 742 that are included in a particular machine will depend on the type of machine. For example, portable machines such as mobile phones will likely include a touch input device or other such input mechanisms, while a headless server machine will likely not include such a touch input device. It will be appreciated that the I/O components 742 may include many other components that are not shown in FIG. 7. The I/O components 742 are grouped according to functionality merely for simplifying the following discussion and the grouping is in no way limiting. In various examples, the I/O components 742 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 742 may include biometric components 732, motion components 734, environmental components 736, or position components 738, among a wide array of other components. For example, the biometric components 732 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 742 may include communication components 740 operable to couple the machine 700 to a network 720 or devices 722 via a coupling 724 and a coupling 726, respectively. For example, the communication components 740 may include a network interface component or another suitable device to interface with the network 720. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 722 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 704, main memory 712, static memory 714, and/or memory of the processors 702) and/or storage unit 716 may store one or more sets of instructions and data structures (e.g., software) embodying or utilized by any one or more of the methodologies or functions described herein. These instructions (e.g., the instructions 708), when executed by processors 702, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Recapitulation of Examplified Aspects

A first aspect of the disclosure comprises a method performed during powered flight of an aircraft having a rotary propulsion system that includes a set of propulsion units respectively mounted at spaced thrust stations on an airframe of the aircraft, the method including monitoring distributed vibration characteristics of the aircraft represented by vibration data comprising a plurality of vibration signals indicating cyclical motion experienced at a corresponding plurality of distributed sensor locations. The method further includes, based on the vibration data, identifying a rotary imbalance event, performing controlled modification of a rotary speed of a target unit selected from the set of propulsion units, and in an automated operation that is performed using one or more computer processor devices configured therefor, identifying the target unit as event unit causative of the rotary imbalance event based at least in part on frequency-domain analysis of the distributed vibration characteristics following the controlled speed modification of the target unit. The method further comprises, responsive to and conditional upon identifying the event unit, automatically executing a mitigation procedure with respect to the event unit.

The method may also include where the vibration data includes, for each of the set of propulsion units, an associated vibration signal captured at the respective propulsion unit, and where said identification of the target unit as the event unit is at least in part conditional on identifying frequency-domain variations associated with the rotary imbalance event in off-target vibration signals, being the respective vibration signals of one or more propulsion units other than the target unit.

The method may further include, responsive to failure to identify the target unit as event unit selecting a further one of the set of propulsion units as second target unit, and repeating controlled speed modification and event unit identification operations with respect to the second target unit.

The mitigation procedure in some examples includes down-regulating the rotary speed of the event unit. Instead, or in addition, the mitigation procedure includes shutting down the event unit. Other technical features may be readily apparent to one skilled in the art from the following figures, descriptions, and claims.

Another aspect of the disclosure comprises an aircraft having incorporated therein a vibration event detection and mitigation system. The aircraft includes a plurality of rotary propulsion units mounted at respective locations on an airframe to generate thrust. The aircraft also includes a vibration monitoring system configured to monitor distributed vibration characteristics of the aircraft by capturing vibration data that includes a plurality of vibration signals sourced at a corresponding plurality of distributed sensor locations on the airframe. The aircraft also includes one or more processors configured to analyze the vibration data to identify a rotary imbalance event, to perform controlled modification of a rotary speed of a target propulsion unit selected from the plurality of propulsion units, identify the target unit as event unit causative of the rotary imbalance event based at least in part on frequency-domain analysis of the distributed vibration characteristics following the controlled speed modification of the target unit, and responsive to and conditional upon identifying the event unit, automatically executing a mitigation procedure with respect to the event unit.

The vibration data in some examples include, for each of the set of propulsion units, an associated vibration signal captured at the respective propulsion unit, said identification of the target unit as the event unit being at least in part conditional on identifying frequency-domain variations associated with the rotary imbalance event in off-target vibration signals, being the respective vibration signals of one or more propulsion units other than the target unit.

The vibration monitoring system may be configured to select a particular one of the set of propulsion units as target unit based at least in part on identifying that propulsion unit whose respective vibration signal reflects a largest amplitude for the vibration anomaly.

The vibration monitoring system may be configured to, responsive to failure to identify the target propulsion unit as the event unit, select a different propulsion unit as a new target propulsion unit, and repeat the controlled speed modification and imbalance identification for the new target propulsion unit.

A further aspect of the disclosure includes a system that includes one or more computer processor devices and memory having stored thereon instructions for causing the one or more computer processor devices, when executing the instruction, to perform a method consistent with the first aspect of the disclosure summarized above.

A fourth aspect of the disclosure comprises a method for identifying a source of vibration in an aircraft having a plurality of propulsion units, the method comprising:
operating each of the plurality of propulsion units at a respective rotary speed;
operating a particular one of the propulsion units at a unique rotary speed different from the rotary speeds of the remaining propulsion units;
detecting a vibration anomaly having an above-threshold amplitude at corresponding vibration frequency; and
identifying the particular propulsion unit as a source of the vibration anomaly based on determining correspondence between the vibration frequency and the unique rotary speed of the particular propulsion unit.

The method may further comprise:
initially operating a plurality of the propulsion units, including the particular propulsion unit, at a baseline rotary speed shared by the plurality of propulsion units;
responsive to detection of the vibration anomaly, applying to the particular propulsion unit an offset to the baseline rotational, thus causing the particular propulsion unit to operate at a modified speed different from the baseline rotary speed and different from the rotary speeds of the remainder of propulsion units of the aircraft; and
identifying the selected propulsion unit as the source if the vibration anomaly frequency corresponds to its unique rotary speed.

The method may further comprise respective aspects and features of a method consistent with the first aspect summarized above. Further aspects of the disclosure include a system configured to implement the method, and an aircraft having incorporated therein such a system.

From the material described and illustrated herein, it will be seen that a number of example embodiments and combinations of example embodiments are disclosed. The disclosed embodiments include but are not limited to the enumerated list of example embodiments that follow:
Example 1: A method performed during powered flight of an aircraft having a rotary propulsion system comprising a set of propulsion units mounted at a plurality of respective spaced thrust stations on an airframe of the aircraft, the method comprising:
   operating a particular one of the propulsion units at a unique rotary speed relative to the respective rotary speeds of other propulsion units of the set;
   monitoring vibration data captured by a vibration sensor system integrated in the aircraft;
   detecting, based on the vibration data, a vibration anomaly having an above-threshold amplitude at corresponding anomaly frequency;
   in an automated operation that comprises processing the vibration data using one or more computer processor devices configured therefor, identifying the particular propulsion unit as an event unit causative of the vibration anomaly based on frequency-domain analysis of the anomaly frequency relative to the unique rotary speed of the particular propulsion unit; and
   responsive to and conditional upon identifying the event unit, automatically executing a mitigation procedure with respect to the event unit.
Example 2: The method of claim 1, further comprising:
   based at least in part detecting the vibration anomaly, identifying a rotary imbalance event; and
   responsive to detecting the rotary imbalance event, performing controlled modification of a rotary speed of one or more of the propulsion units such that a particular propulsion unit from the set operates at a unique rotary speed different from rotary speeds of other propulsion units of the set,
   wherein the identifying of the event unit is performed following said controlled speed modification.
Example 3: The method of claim 2, wherein performing the controlled modification comprises operating the set of propulsion units such that each propulsion unit of the set operates post-modulation at a respectively unique rotational speed different from rotational speeds of all other propulsion units of the set.
Example 4: The method of claim 3, wherein identifying the event unit comprises identifying a correlation in frequency between:
   the unique rotational speed of the event unit; and
   one or more above-threshold spikes in the vibration data at one or more of:
      a fundamental frequency corresponding to the unique rotational speed; and
      a harmonic of the fundamental frequency.
Example 5: The method of claim 3 or claim 4, wherein the frequency-domain analysis comprises order domain analysis, wherein the order domain analysis is additionally based at least in part on a respective tachometer signal for each of the set of propulsion units.
Example 6: The method of claim 2, wherein the controlled speed modification comprises controlled modification of a target propulsion unit selected from the set of propulsion units, such that the target propulsion unit operates post-modulation at said unique rotary speed different from rotary speeds of other propulsion units of the set.
Example 7: The method of claim 6, wherein:
   the vibration data comprises, for each of the set of propulsion units, an associated vibration signal captured at the respective propulsion unit; and
   wherein said identifying of the target unit as the event unit is at least in part conditional on identifying frequency-domain variations associated with the rotary imbalance event in off-target vibration signals, being the respective vibration signals of one or more propulsion units other than the target unit.
Example 8: The method of claim 7, wherein identifying the rotary imbalance event is based at least in part on identifying, based on the vibration data, an above-threshold vibration anomaly at a pre-modulation event frequency; and
   wherein said identifying of the target unit as the event unit is based at least in part on identifying variation in frequency of said vibration anomaly represented in the off-target vibration signals corresponding to the controlled speed modification of the target unit.
Example 9: The method of claim 8, wherein
   the controlled speed modification of the target unit comprises stepping the rotary speed of the target unit from a pre-modulation speed to a post-modulation speed; and
   wherein identification of the target unit as the event unit is conditional at least in part on identifying, in the off-target vibration signals, satisfaction of identification criteria comprising at least one of:
      absence of the vibration anomaly at the pre-modulation event frequency; and
      emergence of the vibration anomaly at a post-modulation event frequency different from the pre-modulation event frequency and corresponding to the post-modulation speed of the target unit.
Example 10: The method of claim 8, wherein the controlled speed modification of the target unit comprises stepping the rotary speed of the target unit from a pre-modulation speed to a first modulated speed, the method further comprising:
   determining failure of satisfaction of predetermined identification criteria pertaining to variation in vibration characteristics of the off-target vibration signals at one or both frequencies corresponding respectively to the pre-modulation speed and the first modulated speed; and
   responsive to said failure of satisfaction of the identification criteria for the target unit at the first modulated speed, further modifying the rotary speed of the target unit to a second modulated speed which is greater in difference from the pre-modulation speed.
Example 11: The method of claim 10, further comprising:
   determining satisfaction of the identification criteria pertaining to variation in vibration characteristics of the off-target vibration signals at the second modulated speed;
   responsive to said determination of satisfaction of the identification criteria, identifying the target unit as the event unit.
Example 12: The method of claim 10, further comprising
   determining non-satisfaction of the identification criteria pertaining to variation in vibration characteristics of the off-target vibration signals at the second modulated speed;
   responsive to said determination of non-satisfaction of the identification criteria, excluding the target unit from identification as the event unit.
Example 13: The method of any one of claims 8-11, further comprising:
   selecting said particular propulsion unit as target unit based at least in part on identifying that propulsion unit whose respective vibration signal reflects a largest amplitude for the vibration anomaly.
Example 14: The method of any one of claims 6-9 or claim 13, further comprising, responsive to failure to identify the target unit as event unit:
   selecting a further one of the set of propulsion units as second target unit; and
   repeating controlled speed modification and event unit identification operations with respect to the second target unit.
Example 15: The method of claim 14, further comprising, responsive to failure to identify the second target unit as event unit:
   iteratively proceeding sequentially through the set of propulsion units until an event unit is identified, each iteration comprising repetition of said target unit selection operation, said controlled speed modification, and said event unit identification operation.
Example 16: The method of claim 6, wherein the mitigation procedure comprises down-regulating the rotary speed of the event unit.
Example 17: The method of claim 6, wherein the mitigation procedure comprises shutting down the event unit.
Example 18: An aircraft comprising:
   an airframe;
   a plurality of rotary propulsion units mounted at respective locations on the airframe to generate thrust;
   a vibration monitoring system configured to monitor distributed vibration characteristics of the aircraft by capturing sensor data comprising a plurality of vibration signals sourced at a corresponding plurality of distributed sensor locations on the airframe; and
   one or more processors configured to perform automated procedures according to the method of any one of claims 1-17.
Example 19: A system for in-flight vibration event management in an aircraft having a rotary propulsion system comprising a set of propulsion units respectively mounted at spaced thrust stations on an airframe of the aircraft, the system comprising one or more computer processor devices configured to perform operations comprising the method of any one of claims 1-17.
Example 20: The system of claim 19, wherein the system comprises:
   the one or more computer processor devices; and
   memory having stored thereon instructions for causing the one or more computer processor devices, when executing the instruction, to perform operations comprising the method of any one of claims 1-17.
Example 21: A computer-readable medium having stored thereon instructions for causing one or more computer processor devices when executing the instructions to perform, in an aircraft having a rotary propulsion system comprising a set of propulsion units respectively mounted at spaced thrust stations on an airframe of the aircraft, operations comprising the method of any one of claims 1-17.

### GLOSSARY

Airframe refers to the mechanical structure of an aircraft, including the fuselage, wings, empennage (tail assembly), landing gear, engine pylons, control surfaces, and other components. It is the physical structure that supports the aircraft.

Fuselage refers specifically to the main body structure or cabin of an aircraft, which holds crew, passengers, and/or cargo. It is one component of the overall airframe.

Motors of the power system can be integrated into a propeller and/or include an integrated inverter, or can be otherwise suitably connected to an inverter and/or propeller. Accordingly, the term “electric propulsion unit” (EPU) as referenced herein can refer to any suitable motor, propeller, and/or inverter system. The term “rotor” as utilized herein, in relation to portions of the power system or otherwise, can refer to a rotor, a propeller, and/or any other suitable rotary aerodynamic actuator. While a rotor can refer to a rotary aerodynamic actuator that makes use of an articulated or semi-rigid hub (e.g., wherein the connection of the blades to the hub can be articulated, flexible, rigid, and/or otherwise connected), and a propeller can refer to a rotary aerodynamic actuator that makes use of a rigid hub (e.g., wherein the connection of the blades to the hub can be articulated, flexible, rigid, and/or otherwise connected), no such distinction is explicit or implied when used herein, and the usage of “rotor” can refer to either configuration, and any other suitable configuration of articulated or rigid blades, and/or any other suitable configuration of blade connections to a central member or hub. Likewise, the usage of “propeller” can refer to either configuration, and any other suitable configuration of articulated or rigid blades, and/or any other suitable configuration of blade connections to a central member or hub. Accordingly, the tiltrotor aircraft can be referred to as a tilt-propeller aircraft, a tilt-prop aircraft, and/or otherwise suitably referred to or described.

What is claimed is:

1. A method performed during powered flight of an aircraft having a rotary propulsion system comprising a set of propulsion units mounted at a plurality of respective spaced thrust stations on an airframe of the aircraft, the method comprising:
operating a particular one of the propulsion units at a unique rotary speed relative to the respective rotary speeds of other propulsion units of the set;
monitoring vibration data captured by a vibration sensor system integrated in the aircraft;
detecting, based on the vibration data, a vibration anomaly having an above-threshold amplitude at a corresponding anomaly frequency;
in an automated operation that comprises processing the vibration data using one or more computer processor devices configured therefor, identifying the particular propulsion unit as an event unit causative of the vibration anomaly based on frequency-domain analysis of the anomaly frequency relative to the unique rotary speed of the particular propulsion unit; and
responsive to and conditional upon identifying the event unit, automatically executing a mitigation procedure with respect to the event unit.

2. The method of claim 1, further comprising:
based at least in part on detecting the vibration anomaly, identifying a rotary imbalance event; and
responsive to detecting the rotary imbalance event, performing controlled modification of a rotary speed of one or more of the propulsion units such that a particular propulsion unit from the set operates at a unique rotary speed different from rotary speeds of other propulsion units of the set,
wherein the identifying of the event unit is performed following said controlled speed modification.

3. The method of claim 2, wherein performing the controlled modification comprises operating the set of propulsion units such that each propulsion unit of the set operates post-modulation at a respective unique rotational speed different from rotational speeds of all other propulsion units of the set.

4. The method of claim 2, wherein the controlled speed modification comprises controlled modification of a target propulsion unit selected from the set of propulsion units, such that the target propulsion unit operates post-modulation at said unique rotary speed different from rotary speeds of other propulsion units of the set.

5. The method of claim 4, wherein:
the vibration data comprises, for each of the set of propulsion units, an associated vibration signal captured at the respective propulsion unit; and
wherein said identifying of the target unit as the event unit is at least in part conditional on identifying frequency-domain variations associated with the rotary imbalance event in off-target vibration signals, being the respective vibration signals of one or more propulsion units other than the target unit.

6. The method of claim 5, wherein identifying the rotary imbalance event is based at least in part on identifying, based on the vibration data, an above-threshold vibration anomaly at a pre-modulation event frequency; and
wherein said identifying of the target unit as the event unit is based at least in part on identifying variation in frequency of said vibration anomaly represented in the off-target vibration signals corresponding to the controlled speed modification of the target unit.

7. The method of claim 6, wherein
the controlled speed modification of the target unit comprises stepping the rotary speed of the target unit from a pre-modulation speed to a post-modulation speed; and
wherein identification of the target unit as the event unit is conditional at least in part on identifying, in the off-target vibration signals, satisfaction of identification criteria comprising at least one of:
absence of the vibration anomaly at the pre-modulation event frequency; and
emergence of the vibration anomaly at a post-modulation event frequency different from the pre-modulation event frequency and corresponding to the post-modulation speed of the target unit.

8. The method of claim 6, wherein the controlled speed modification of the target unit comprises stepping the rotary speed of the target unit from a pre-modulation speed to a first modulated speed, the method further comprising:
determining failure of satisfaction of predetermined identification criteria pertaining to variation in vibration characteristics of the off-target vibration signals at one or both frequencies corresponding respectively to the pre-modulation speed and the first modulated speed; and
responsive to said failure of satisfaction of the identification criteria for the target unit at the first modulated speed, further modifying the rotary speed of the target unit to a second modulated speed which is greater in difference from the pre-modulation speed.

9. The method of claim 8, further comprising:
determining satisfaction of the identification criteria pertaining to variation in vibration characteristics of the off-target vibration signals at the second modulated speed;
responsive to said determination of satisfaction of the identification criteria, identifying the target unit as the event unit.

10. The method of claim 8, further comprising
determining non-satisfaction of the identification criteria pertaining to variation in vibration characteristics of the off-target vibration signals at the second modulated speed;
responsive to said determination of non-satisfaction of the identification criteria, excluding the target unit from identification as the event unit.

11. The method of claim 6, further comprising:
selecting said particular propulsion unit as target unit based at least in part on identifying that propulsion unit whose respective vibration signal reflects a largest amplitude for the vibration anomaly.

12. The method of claim 4, further comprising, responsive to failure to identify the target unit as event unit:
selecting a further one of the set of propulsion units as second target unit; and
repeating controlled speed modification and event unit identification operations with respect to the second target unit.

13. The method of claim 12, further comprising, responsive to failure to identify the second target unit as event unit:
iteratively proceeding sequentially through the set of propulsion units until an event unit is identified, each iteration comprising repetition of said target unit selection operation, said controlled speed modification, and said event unit identification operation.

14. An aircraft comprising:
an airframe;
a rotary propulsion system comprising a set of propulsion units mounted at a plurality of respective spaced thrust stations on and configured to generate flight-enabling thrust;
a vibration sensor system configured to capture sensor data comprising a plurality of vibration signals sourced at a corresponding plurality of distributed sensor locations on the airframe; and
one or more processors carried by the airframe and configured to perform automated operations comprising:
operating a particular one of the propulsion units at a unique rotary speed relative to the respective rotary speeds of other propulsion units of the set;
monitoring vibration data captured by the vibration sensor system;
detecting, based on the vibration data, a vibration anomaly having an above-threshold amplitude at a corresponding anomaly frequency;
based on processing the vibration data, identifying the particular propulsion unit as an event unit causative of the vibration anomaly based on frequency-domain analysis of the anomaly frequency relative to the unique rotary speed of the particular propulsion unit; and
responsive to and conditional upon identifying the event unit, automatically executing a mitigation procedure with respect to the event unit.

15. The aircraft of claim 14, further comprising:
based at least in part on detecting the vibration anomaly, identifying a rotary imbalance event; and
responsive to detecting the rotary imbalance event, performing controlled modification of a rotary speed of one or more of the propulsion units such that a particular propulsion unit from the set operates at a unique rotary speed different from rotary speeds of other propulsion units of the set,
wherein the identifying of the event unit is performed following said controlled speed modification.

16. The aircraft of claim 15, wherein performing the controlled modification comprises operating the set of propulsion units such that each propulsion unit of the set operates post-modulation at a respective unique rotational speed different from rotational speeds of all other propulsion units of the set.

17. The aircraft of claim 16, wherein identifying the event unit comprises identifying a correlation in frequency between:
the unique rotational speed of the event unit; and
one or more above-threshold spikes in the vibration data at one or more of:
a fundamental frequency corresponding to the unique rotational speed; and
a harmonic of the fundamental frequency.

18. The aircraft of claim 16, wherein the frequency-domain analysis comprises order domain analysis, wherein the order domain analysis is additionally based at least in part on a respective tachometer signal for each of the set of propulsion units.

19. The aircraft of claim 14, wherein the mitigation procedure comprises down-regulating the rotary speed of the event unit.

20. A system for in-flight vibration event management in an aircraft having a rotary propulsion system comprising a set of propulsion units respectively mounted at spaced thrust stations on an airframe of the aircraft, the system comprising:
one or more computer processor devices; and
memory having stored thereon instructions for causing the one or more computer processor devices, when executing the instruction, to perform operations comprising:
operating a particular one of the propulsion units at a unique rotary speed relative to the respective rotary speeds of other propulsion units of the set;
monitoring vibration data captured by a vibration sensor system integrated in the aircraft;
detecting, based on the vibration data, a vibration anomaly having an above-threshold amplitude at a corresponding anomaly frequency;
based on processing the vibration data, identifying the particular propulsion unit as an event unit causative of the vibration anomaly based on frequency-domain analysis of the anomaly frequency relative to the unique rotary speed of the particular propulsion unit; and
responsive to and conditional upon identifying the event unit, automatically executing a mitigation procedure with respect to the event unit.
